(19) United States
(12) Patent Application Publication
(10) Pub. No.: US 2026/0333356 A1
(43) Pub. Date: Oct. 22, 2026

(54) PHYSICAL UPLINK SHARED CHANNEL (PUSCH) FOR SUBBAND FULL DUPLEX OPERATION

(71) Applicant: Telefonaktiebolaget LM Ericsson (publ), Stockholm (SE)

(72) Inventors: Stephen GRANT, Pleasanton, CA (US); Jung-Fu CHENG, Fremont, CA (US)

(21) Appl. No.: 19/100,761

(22) PCT Filed: Aug. 11, 2023
(86) PCT No.: PCT/SE2023/050817

§ 371 Date: Feb. 3, 2025

Related U.S. Application Data
(60) Provisional application No. 63/397,722, filed on Aug. 12, 2022.

(51) Int. Cl. H04W 72/21; H04L 5/14

(52) U.S. Cl. CPC H04W 72/21; H04L 5/14

(57) ABSTRACT

A method, system and apparatus are disclosed. A wireless device configured to communicate with a network node is provided. The wireless device is configured to receive control signaling for a physical uplink shared channel, PUSCH, transmission. The wireless device is configured to perform the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

### TECHNICAL FIELD

The present disclosure relates to wireless communications, and in particular, to configuring an uplink channel for subband full duplex operation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

3GPP NR may be designed to provide service for multiple use cases such as enhanced mobile broadband (eMBB), ultra-reliable and low latency communication (URLLC), and machine type communication (MTC). Each of these services may have different technical requirements. For example, a requirement for eMBB may be a high data rate with moderate latency and moderate coverage, while URLLC service may require a low latency and high reliability transmission, e.g., with moderate data rates.

One technique in existing systems for low latency data transmission includes configuring shorter transmission time intervals. In NR, in addition to transmission in a slot, a mini-slot transmission may also be configured, e.g., to reduce latency. A mini-slot may include any number of 1 to 14 OFDM symbols. It should be noted that the concepts of slot and mini-slot are not specific to a specific service, e.g., a mini-slot may be used for either eMBB, URLLC, or other services, etc.

FIG. 1 illustrates an example radio resource configuration in NR. In 3GPP Rel-15 NR, a wireless device may be configured with up to four carrier bandwidth parts (BWP) in the downlink with a single downlink carrier bandwidth part being active at a given time. A wireless device may be configured with up to four carrier bandwidth parts in the uplink with a single uplink carrier bandwidth part being active at a given time.

A 3GPP NR slot includes several OFDM symbols, according to current agreements either 7 or 14 symbols (OFDM subcarrier spacing ≤60 kHz) and 14 symbols (OFDM subcarrier spacing >60 kHz). FIG. 2 illustrates an example configuration of a subframe with 14 OFDM symbols. In FIG. 2, Tₛ and T_{symb} denote the slot and symbol duration, respectively.

### FDD and TDD Systems

Transmission and reception from a node, e.g., a terminal in a cellular system, can be multiplexed in the frequency domain or in the time domain (or combinations thereof). Frequency Division Duplex (FDD), as illustrated in the left-hand panel of FIG. 3, implies that downlink and uplink transmission take place in different, sufficiently separated, frequency bands. Time Division Duplex (TDD), as illustrated to the right in FIG. 3, implies that downlink and uplink transmission take place in different, non-overlapping time slots. Thus, TDD can operate in unpaired spectrum, whereas FDD requires paired spectrum.

Typically, the structure of the transmitted signal in a communication system is organized in the form of a frame structure. For example, NR uses ten equally-sized slots per radio frame as illustrated in FIG. 4 for the case of 15 kHz subcarrier spacing.

In cases of FDD operation (e.g., the upper panel of FIG. 4), there are two carrier frequencies, one for uplink transmission (fUL) and one for downlink transmission (fDL). At least with respect to the terminal in a cellular communication system, FDD can be either full duplex or half duplex. In the full duplex case, a terminal can transmit and receive simultaneously, while in half-duplex operation, the terminal cannot transmit and receive simultaneously (the base station is capable of simultaneous reception/transmission though, e.g., receiving from one terminal while simultaneously transmitting to another terminal). In LTE, a half-duplex terminal is monitoring/receiving in the downlink except when explicitly being instructed to transmit in a certain subframe.

FIG. 4 illustrates an example uplink/downlink time/frequency structure in case of FDD or TDD. In case of TDD operation (lower part of FIG. 4), there is only a single carrier frequency and uplink and downlink transmissions are separated in time, which may also be configured on a cell-by-cell basis. As the same carrier frequency is used for uplink and downlink transmission, both the base station and the mobile terminals need to switch from transmission to reception and vice versa. TDD systems may be configured to provide for a sufficiently large guard time, e.g., where neither downlink nor uplink transmissions occur. This may be required, for example, to avoid interference, e.g., between uplink and downlink transmissions. For NR, this guard time may be provided by special subframes, which, for example, may be split into three parts: symbols for DL, a guard period (GP), and symbols for uplink. The remaining subframes may be either allocated to uplink or downlink transmission.

For example, the following two information elements (IEs) are defined in current NR specifications. The TDD pattern is typically configured with at least the first IE and optionally the 2nd IE:
TDD-DL-UL-ConfigCommon (cell-specific); and
TDD-DL-UL-ConfigDedicated (WD-specific).

The first IE is cell specific (common to all WDs) and is provided by broadcast signaling. It provides the number of slots in the TDD pattern via a reference subcarrier spacing and a periodicity such that the S-slot pattern repeats every S slots. This may IE allow for flexible configuration of the pattern, for example, characterized by one or more of the following parameters:
A number of full downlink slots at the beginning of the pattern configured by the parameter nDownlinkSlots;
A number of full uplink slots at the end of the pattern configured by the parameter nUplinkSlots;
A number of downlink (‘D’) symbols following the full downlink slots configured by the parameter nDownlinkSymbols;
A number of uplink (‘U’) symbols preceding the full downlink slots configured by the parameter nUplinkSlots;
If there is a gap between the last downlink symbol and the first uplink symbol, then all symbols in the gap are characterized as flexible (‘F’). A symbol classified as ‘F’ can be used for downlink or uplink. A wireless device may determine the direction in one of the following two ways:
   Detecting a DCI that schedules/triggers a DL signal/channel, e.g., PDSCH, CSI-RS or schedules/triggers an UL signal/channel, e.g., PUSCH, SRS, etc.; and
   By dedicated (WD-specific) signaling of the IE TDD-DL-UL-ConfigDedicated. This parameter overrides some or all of the ‘F’ symbols in the pattern, thus providing a semi-static indication of whether a symbol is classified as ‘D’ or ‘U’.
Optionally, a 2nd pattern that is concatenated to the first pattern may be configured as above. For example, if a 2nd pattern is configured, an example constraint is that the sum of the periodicities of the two patterns must evenly divide 20 ms.

FIG. 5 illustrates an example TDD DL/UL pattern including S=5 slots. TDD-DL-UL-ConfigCommon configures the cell-specific pattern, and TDD-DL-UL-ConfigDedicated (if provided) WD-specifically configures the direction for some or all of the ‘F’ symbols in the cell-specific pattern.

In the example configuration of FIG. 5, the TDD DL/UL pattern is configured by TDD-DL-UL-ConfigCommon. The configuration includes, for example, 3 full ‘D’ slots, 1 full ‘U’ slot, with a mixed slot in between including 4 ‘D’ symbols and 3 ‘U’ symbols. The remaining 7 symbols in the mixed slot in this example are classified as ‘F.’

Still referring to FIG. 5, if a wireless device is not configured with TDD-DL-UL-ConfigDedicated, then the pattern at the top of the diagram may be the configured pattern. As stated above, the network node may make use of the ‘F’ symbols flexibly, by scheduling/triggering either an uplink or a downlink signal/channel in a wireless device-specific manner. This may allow for dynamic behavior, e.g., the direction may not be known to the wireless device a priori; rather, the direction may become known once the wireless device detects a DCI scheduling/triggering a particular DL or UL signal/channel.

In contrast, the DL/UL direction for some or all of the ‘F’ symbols in a particular slot can be provided to the wireless device in a semi-static manner by RRC configuring the wireless device with TDD-DL-UL-ConfigDedicated. The lower part of FIG. 5 shows 3 example configurations for overriding ‘F’ symbols in Slot 3. If the IE indicates ‘allDownlink’ or ‘allUplink’ for a particular slot (or slots), then all ‘F’ symbols in the slot are converted to either ‘D’ or ‘U,’ respectively. If the IE indicates ‘explicit,’ then a number of symbols at the beginning of the slot and/or a number of symbols at the end of the slot are indicated as ‘D’ and ‘U,’ respectively. In the example below, the first 7 and the last 5 are indicated as ‘D’ and ‘U’, which converts some of the ‘F’ symbols (but not all in this example) to ‘D’ and ‘U.’

In the above examples, the WD-specific IE TDD-DL-UL-ConfigDedicated can only override (i.e., specify ‘D’ or ‘U’) for symbols that are configured as ‘F’ by the cell-specific IE TDD-DL-UL-ConfigCommon. In other words, a WD does not expect to have a ‘D’ symbol converted to ‘U’ or vice versa.

FIG. 6A, FIG. 6B, and FIG. 6C illustrate three additional example cell-specific TDD DL/UL patterns A, B, and C. The three example TDD DL/UL patterns may be configured by TDD-DL-UL-ConfigCommon. In the first and second patterns, there are no ‘F’ symbols, hence according to current behavior in the Rel-17 specifications, for example, the WD would not expect to be configured with TDD-DL-UL-ConfigDedicated. In the second pattern, all symbols in Slots 1, 2, and 3 are configured as ‘F;’ hence, the WD could be configured with TDD-DL-UL-ConfigDedicated to provide a direction (‘D’ or ‘U’) for any or all symbols in these 3 slots. Note that some existing systems (e.g., NR Rel-17) allow the dedicated configuration of the TDD pattern on a slot-specific basis. In other words, in some existing systems, TDD-DL-UL-ConfigDedicated is not restricted to be the same in each slot where ‘F’ symbols are overridden.

### Subband Full Duplex

As described above, in a conventional TDD system, entire carrier BW or all carriers in the same frequency band need to be utilizing the same DL transmission or UL reception direction. For example, FIG. 7 illustrates conventional TDD carrier or carrier systems. For the 3GPP Rel-18 evolution of the NR system, 3GPP has considered studying the technical feasibilities and potential benefits of subband full duplex (SBFD) systems. FIG. 8 illustrates an example configuration for subband full duplex systems.

In such a system, a portion of a wide bandwidth carrier may be used for a different direction than that of the rest of the carrier. This is illustrated in the left-hand side of FIG. 8. That is, unlike a conventional TDD system as shown on the left-hand side of FIG. 7 where the entire bandwidth is used for DL transmission in the first three slots, the center portion of the SBFD carrier is used for UL reception while the rest of the carrier continues to be used for DL transmission as shown in the left-hand side of FIG. 8.

Similarly, instead of utilizing all carriers for the same DL or UL directions in a conventional TDD system as shown in the right-hand side of FIG. 7, some carriers in the SBFD system can be used for a different direction than that of the other carriers as shown in the right-hand side of FIG. 8.

3GPP Rel-18 has considered SBFD operation for network nodes (e.g., gNBs) which transmit DL and receive UL simultaneously, where an individual WD is scheduled in only one direction (DL or UL) at a time.

For example, some existing systems provide methods for configuration of one or more OFDM symbols of a slot with two or more “RB sets” where each RB set corresponds to a frequency domain subband and has a defined transmission direction (‘D’ or ‘U’). The RB sets may have gaps between them that serve as guardbands where neither DL or UL transmission occurs. FIG. 9 illustrates example configurations of 3 RB sets in an SBFD symbol configured as (a) D-U-D and (b) as U-D-U. In other words, in FIG. 9, there are two example RB set configurations, one with D-U-D configuration and the other with U-D-U configuration. The RB sets are configured either by introduction of new RRC parameter(s) or enhancement of an existing RRC parameter, e.g., TDD-UL-DL-ConfigDedicated. In either case, the parameter(s) signal the size and frequency domain location of the RB sets as well as which symbols/slots in the TDD UL/DL pattern are configured with RB sets.

### Advanced Antenna Arrays for TDD Systems

Some modern cellular wireless communication systems utilize advance antenna array systems to perform beamforming and MIMO transmission in order to enhance the coverage and throughput of the system. A generic example antenna array for a TDD system is illustrated in FIG. 10, e.g., a TDD antenna array with 32 cross-polarized antenna elements (64 elements in total). In such an example array, multiple antenna elements may be utilized and typically placed in a planar array with horizontal and vertical spacings suitable for the operating frequency bands. For a TDD base station, the antenna array may be connected to a TX/RX switch such that the same antenna array can be used for transmitting DL signals in a DL slot as well as used for receiving UL signals in an UL slot

### Antenna Architecture I for SBFD Systems

FIG. 11 illustrates an example antenna architecture I for SBFD systems. In an SBFD system, the network node (e.g., base station) may need to perform DL transmission and UL reception simultaneously. It hence may be necessary to utilize two antenna arrays for the two directions, respectively as illustrated in the example of FIG. 11:
A first antenna array is utilized for UL reception only; and
A second antenna array is utilized for DL transmission only.

It also generally may be necessary to introduce additional isolation material or mechanisms between the two antenna arrays to suppress the signal leaking from the TX array into the RX array Without such isolation, the UL receiver may be de-sensitized, e.g., due to the DL transmit power being generally much higher than the UL receive power.

### Frequency Domain Resource Allocation (FDRA) and Frequency Hopping for PUSCH.

In some existing systems, multi-slot PUSCH (e.g., PUSCH with some form of repetition across slots) may be configured in a variety of ways, for example:
3GPP Rel-15 includes semi-statically configured repetition via the RRC parameter pusch-AggregationFactor for dedicated grant (DG)-PUSCH;
3GPP Rel-16 includes dynamically indicated repetition via the parameter nrofRepetitions configured as part of the TDRA table for DG-PUSCH;
3GPP Rel-16 includes semi-statically configured repetition via RRC parameters cg-nrofSlots for CG-PUSCH;
3GPP Rel-17 includes Msg3 repetition where the number of repetitions is indicated by repurposing bits from the MCS field in either the RAR UL grant carried in Msg2 or by Msg3 retransmission scheduled by DCI 0_0 with CRC scrambled by TC-RNTI; and
3GPP Rel-17 includes transport block over multiple-slots (TBoMS) for DG-PUSCH where the number of slots (2, 4, or 8) over which a single transport block spans is configured by the RRC parameter numberOfSlots-TBoMS. This can be configured in combination with Rel-16 repetition.

In some existing systems, one or more of the above repetition types may be configured or assumed to be so-called Type A repetition. Type B repetition can be configured only for DG and CG-PUSCH (not Msg3 repetition or TBoMs), and differs mainly in how repetitions are defined within a slot and between slots, specifically for PUSCH mapping Type B, also known as mini-slots.

In some existing systems, a single indication of frequency domain resource assignment (FDRA) may apply to all PUSCH repetitions. For PUSCH scheduled by DCI and Type-2 CG-PUSCH, this may be indicated by the FDRA field in DCI. This field indicates the specific PRBs of the PUSCH allocation in the frequency domain. For Type-1 CG-PUSCH, the FDRA is indicated by an RRC parameter as part of the CG configuration. For PUSCH scheduled by RAR UL grant, it is indicated by the FDRA field in the RAR UL grant carried in Msg2.

Frequency hopping for PUSCH can be enabled or disabled dynamically or semi-statically, for example, as follows:
Dynamically for PUSCH scheduled by DCI or RAR UL grant;
   A 1-bit flag in DCI/RAR UL grant indicates whether frequency hopping for PUSCH is enabled or disabled;
Semi-statically for CG-PUSCH;
   Whether or not frequency hopping is enabled is determined by the presence/absence of the RRC parameter frequencyHopping in the configured grant configuration.

If enabled, frequency hopping for PUSCH alternates between a first hop and a second hop. The starting PRB of the 1st hop is simply the first PRB indicated by the FDRA field in either DCI, RAR UL grant, or configured grant configuration. The starting PRB of the 2nd hop is related to that of the 1st hop by an RB offset. The RB offset to be used for the 2nd hop is indicated either dynamically or semi-statically as follows:
Dynamically for PUSCH scheduled by DCI with CRC scrambled by RNTI other than TC-RNTI and for Type-2 CG-PUSCH;
   If frequency hopping is enabled, N_{UL_hop} bits (1 or 2) of the FDRA field in the scheduling/activating DCI (see FIG. 12, discussed below) indicates the RB offset from a length 2 or 4 list, respectively, configured by RRC. The list frequencyHoppingOffsetLists in pusch-Config applies to DCI 0_0/0_1, and the list frequency HoppingOffsetListsDCI-0-2 applies to DCI 0_2. Each element of the list has a value range from 1 . . . 274 allowing the RB offset to be configured very flexibly.
Dynamically for PUSCH scheduled by RAR UL grant (Msg3) and for PUSCH scheduled by DCI 0_0 with CRC scrambled by TC-RNTI (Msg3 re-transmission);
   If frequency hopping is enabled, N_{UL_hop} bits (1 or 2) of the FDRA field of the RAR UL grant or scheduling DCI (see FIG. 12, discussed below) indicates the RB offset based on the following table specified in 3GPP TS 38.213 Section 8.3. Notice that the allowed RB offsets are not as flexible as for the case of PUSCH scheduled in CONNECTED mode. For IDLE mode the RB offsets are constrained to values ½ and ¼ of the BWP size.

TABLE 1
Frequency offset for second hop of PUSCH transmission with frequency
hopping scheduled by RAR UL grant or of Msg3 PUSCH
retransmission -Semi-statically for Type-1 CG-PUSCH;

| Number of PRBs in | Value of N_{UL, hop} | Frequency offset |
|---|---|---|
| initial UL BWP | Hopping Bits | for 2^{nd} hop |
| ${N}_{BWP}^{size} < 50$ | 0 | $⌊ {N}_{BWP}^{size} / 2 ⌋$ |
| | 1 | $⌊ {N}_{BWP}^{size} / 4 ⌋$ |
| ${N}_{BWP}^{size} \geq 50$ | 00 | $⌊ {N}_{BWP}^{size} / 2 ⌋$ |
| | 01 | $⌊ {N}_{BWP}^{size} / 4 ⌋$ |
| | 10 | $- ⌊ {N}_{BWP}^{size} / 4 ⌋$ |
| | 11 | Reserved |

The RRC parameter frequencyHoppingOffset configures the RB offset.

FIG. 12 illustrates an example configuration N-bit FDRA field for PUSCH. FIG. 12 illustrates the FDRA field either in DCI or in the RAR UL grant that jointly indicates the RB offset for frequency hopping (if enabled), and the PRBs allocated for PUSCH (see). The RB offset for frequency hopping is indicated by N_{UL_hop} bits where N_{UL_hop}=1 or 2 if FH is enabled. If frequency hopping is disabled or Type-0 FDRA is configured, then N_{UL_hop}=0 The remaining N-N_{UL_hop} bits indicate the PRB allocation for the 1st hop. In the existing specifications, N is a function of the size of the BWP. For example, for Type-1 FDRA (contiguous RBs), N is given by, e.g.:

$$N = ⌈ {log}_{2} ( \frac{{N}_{BWP}^{s i z e} ( {N}_{BWP}^{s i z e} + 1 )}{2} ) ⌉$$

In some example systems, frequency hopping can be RRC configured as one of the following types, but not both at the same time:
For no repetition or for PUSCH repetition Type-A:
   Intra-slot frequency hopping, or
   Inter-slot frequency hopping
      Note: Inter-slot not relevant for the case of no-repetition
For PUSCH repetition Type-B:
   Inter-repetition frequency hopping, or
   Inter-slot frequency hopping.

Depending on the configured frequency hopping type, the starting RB for the 1st and 2nd hops is determined differently, for example:
Intra-slot repetition:

$$R {B}_{s t a r t} ( i ) = \{ \begin{matrix}{RB}_{s t a r t} & i = 0 \\ ( {RB}_{s t a r t} + R {B}_{offset} ) mod {N}_{BWP}^{s i z e} & i = 1\end{matrix}$$

The index i=0/1 corresponds to the 1st/2nd hop with a slot. As mentioned previously, the starting PRB RBstart for the 1st hop corresponds to the 1st PRB of the indicated FDRA field. The starting PRB of the 2nd hop is determined as the starting PRB for the 1st hop plus the indicated RB offset RBoffset. The mod function ensures that the starting PRB for the 2nd hop does not step outside the PRBs of the active BWP.
The first hop applies to the first

$$⌊ {N}_{symb}^{PUSCH} / 2 ⌋$$

OFDM symbols of the PUSCH allocation within the slot, and the 2nd hop applies to the remainder of the

$${N}_{s y m b}^{PUSCH}$$

OFDM symbols, e.g.:
Inter-slot repetition:

$$R {B}_{s t a r t} ( {n}_{s , f}^{μ} ) = \{ \begin{matrix}{RB}_{s t a r t} & {n}_{s , f}^{μ} mod 2 = 0 \\ ( {RB}_{s t a r t} + R {B}_{offset} ) mod {N}_{BWP}^{s i z e} & {n}_{s , f}^{μ} mod 2 = 1\end{matrix}$$

The index

$${n}_{s , f}^{μ}$$

is the slot number in the radio frame, hence the first hop occurs in even-numbered slots, and the 2nd hop in odd-numbered slots
Since hopping does not occur within a slot, each hop corresponds to all

$${N}_{symb}^{PUSCH}$$

OFDM symbols of the PUSCH allocation
If DMRS bundling is configured, hops do not occur every slot, but rather every N_{FH} Slots, where N_{FH} is the frequency hopping interval, e.g.:
Inter-repetition hopping

$$R {B}_{s t a r t} ( n ) = \{ \begin{matrix}{RB}_{s t a r t} & n = 0 \\ ( {RB}_{s t a r t} + R {B}_{offset} ) mod {N}_{BWP}^{s i z e} & n = 1\end{matrix}$$

The index n indexes nominal repetitions.

FIG. 13 shows an example configuration of inter-slot hopping for multi-slot PUSCH (Type-A repetition) with 4 repetitions. Because the U slots in the TDD pattern alternate between even and odd slot numbers, the hops do indeed occur. Note that if a length-4 TDD pattern with single U slot was used instead, the U slot would always occur in even numbered slots, and only the 1st hop would ever occur, not the 2nd.

FIG. 14 illustrates an example configuration of Intra-slot frequency hopping for PUSCH repetition Type A with 4 repetitions. Since hopping occurs in every slot by definition, in this example, this type of hopping does not suffer the same dependence on the TDD pattern as inter-slot hopping.

In existing 3GPP Rel-17 systems, there is no support for SBFD operation which is characterized by provision of UL resources within symbols that are used simultaneously by the network node (e.g., gNB) for DL transmission. For the case of PUSCH for SBFD with repetition, existing systems do not support PUSCH transmission over multiple slots in which the number of RBs available for UL transmission is different in different repetitions

In UL-only symbols, the number of available PRBs is equal to the BWP size, denoted

$${N}_{BWP}^{size} .$$

In SBFD symbols, the number of available PRBs is equal to the UL subband size which is less than the BWP size, i.e.,

$${N}_{UL subband}^{s i z e} < {N}_{B W P}^{s i z e}$$

where

$${N}_{UL subband}^{s i z e}$$

denotes the UL subband size. For example, for a 100 MHz carrier with 30 kHz SCS a BWP spanning the whole carrier has size

$${N}_{B W P}^{s i z e} = 273 .$$

For a typical UL subband roughly 20% of the carrier, and accounting for guardbands, the UL subband size is

$${N}_{UL subband}^{s i z e} = 51 .$$

One approach for handling this could be to define a new FDRA field that would apply to the SBFD symbols to indicate the allocated PRBs and frequency hopping within the UL subband. Despite that the size of the new FDRA field would be smaller than the existing one due to that the UL subband size is smaller than the UL BWP, this is still an undesirable solution since it would impact coverage to increase the DCI size or the RAR UL grant size.

Thus, existing systems lack suitable configurations for configuring an uplink channel for subband full duplex operation.

### SUMMARY

Some embodiments advantageously provide methods, systems, and apparatuses for configuring an uplink channel for subband full duplex operation.

In some embodiments of the present disclosure, methods are provided which may enable configuring multi-slot PUSCH transmissions that span both UL-only symbols and SBFD symbols in which the UL frequency domain resources availability is different in both symbol types. Different approaches are disclosed for frequency domain resource allocation either with or without frequency hopping.

Rather than the undesirable solution of introducing a new FDRA field, a more efficient approach may include applying the existing FDRA field to the UL-only symbols “as is,” and re-interpreting certain bits of this field to apply to the UL subband in SBFD symbols. In this way, slot-dependent behavior for frequency hopping and FDRA is achieved for the SBFD symbols vs. UL only symbols for the case when PUSCH spans multiple slots (multi-slot PUSCH). The present disclosure provides methods, systems, and apparatuses which include various approaches for re-interpreting the bits of the existing FDRA field, resulting in slot-dependent behavior for both frequency hopping and FDRA

The present disclosure provides methods for re-interpreting existing frequency hopping and frequency domain resource allocation indication(s) to the wireless device to enable/configure multi-slot PUSCH (PUSCH with repetition) to operate across slots in which the number of available UL resources in the frequency domain may be different in different slots.

An advantage of enabling multi-slot PUSCH transmission (PUSCH with repetition) across both SBFD and UL-only slots includes enabling UL coverage gain for PUSCH which may be provided by SBFD operation in which additional UL transmission opportunities are introduced, i.e., by allowing the network node (e.g., gNB) to receive UL in simultaneously in slots that it uses for DL transmission.

According to one aspect of the present disclosure, a wireless device configured to communicate with a network node is provided. The wireless device is configured to receive an control signaling for a physical uplink shared channel, PUSCH, transmission; and perform the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

According to one or more embodiments of this aspect, the control signaling includes a frequency hopping configuration.

According to one or more embodiments of this aspect, the control signaling includes an indication of a resource block, RB, allocation in a frequency domain for the at least one UL-only symbol, the indication including at least an indication of a starting RB.

According to one or more embodiments of this aspect, the indication further comprises an indication of a number of RBs for the RB allocation.

According to one or more embodiments of this aspect, the control signaling includes at least one of a higher layer configuration and a downlink control information, DCI, indication.

According to one or more embodiments of this aspect, the wireless device performs at least one of inter-slot frequency hopping and intra-slot frequency hopping in the at least one UL-only symbol; and the wireless device does not perform frequency hopping in the at least one SBFD symbol.

According to one or more embodiments of this aspect, the frequency hopping configuration includes a plurality of preconfigured frequency hopping offsets; and the wireless device is further configured to: perform at least one of inter-slot frequency hopping and intra-slot frequency hopping in the at least one UL-only symbol based on a first frequency hopping offset included in a first subset of the plurality of preconfigured frequency hopping offsets; and perform at least one of inter-slot frequency hopping and intra-slot frequency hopping in the at least one SBFD symbol based on a second frequency hopping offset included in a second subset of the plurality of preconfigured frequency hopping offsets.

According to one or more embodiments of this aspect, the frequency hopping configuration includes an SBFD frequency offset that is based on an UL subband size of the at least one SBFD symbol.

According to one or more embodiments of this aspect, the frequency hopping configuration includes an indication of a first frequency hopping offset used for frequency hopping in the at least one UL-only symbol and a second frequency hopping offset used for frequency hopping in the at least one SBFD symbol.

According to one or more embodiments of this aspect, the PUSCH transmission includes a plurality of allocated resource blocks, and the wireless device does not transmit PUSCH in the resource blocks in the at least one SBFD symbol based on some or all of the plurality of allocated resource blocks not being allocated within an UL subband of the at least one SBFD symbol.

According to one or more embodiments of this aspect, the PUSCH transmission includes a plurality of allocated resource blocks; a first portion of the allocated resource blocks being allocated within an UL subband of the at least one SBFD symbol; a second portion of the allocated resource blocks being allocated outside of the UL subband of the at least one SBFD symbol; and the wireless device transmits PUSCH in the first portion of the allocated resource blocks in the at least one SBFD symbol and does not transmit PUSCH in the second portion of the allocated resource blocks in the at least one SBFD symbol.

According to one or more embodiments of this aspect, the PUSCH transmission is allocated resource blocks in the at least one SBFD symbol based on at least one of a subband size of an UL subband of the at least one SBFD symbol and a frequency domain location of the UL subband of the at least one SBFD symbol.

According to one or more embodiments of this aspect, the wireless device transmits PUSCH with or without frequency hopping based on an UL subband size of the at least one SBFD symbol being one of greater than or less than a threshold, respectively.

According to one or more embodiments of this aspect, the frequency hopping configuration includes a first frequency hopping offset used for at least one of inter-slot frequency hopping and intra-slot frequency hopping in the at least one UL-only symbol and at least one of a second and a third frequency hopping offset used for at least one of inter-slot frequency hopping and intra-slot frequency hopping in the at least one SBFD symbol.

According to one or more embodiments of this aspect, each of the second and third frequency hopping offset is based on one of: a frequency domain location of a reference resource block in the at least one UL-only symbol; or a frequency domain location of a reference resource block within an UL subband of the at least one SBFD symbol.

According to one or more embodiments of this aspect at least one of the second and third frequency hopping offsets is at least one of: semi-statically configured; and implicitly determined by the wireless device based on at least one of the size and frequency domain location of an UL subband of the at least one SBFD symbol.

According to one or more embodiments of this aspect, a starting resource block, RB, for an RB allocation in the at least one SBFD symbol is based on at least the starting RB for the RB allocation in the frequency domain for the at least one UL-only symbol and at least one of the second and third frequency hopping offsets.

According to one or more embodiments of this aspect, a starting resource block, RB, for an RB allocation in the at least one SBFD symbol is based on at least a starting RB of an UL subband.

According to one or more embodiments of this aspect, the starting RB for the RB allocation in the at least one SBFD symbol is further based on at least one of the second and third frequency hopping offsets.

According to one or more embodiments of this aspect, the starting RB for the RB allocation in the at least one SBFD symbol is further based on the first frequency hopping offset.

According to one or more embodiments of this aspect, the starting RB for the RB allocation in the at least one SBFD symbol is further based on a UL subband size.

According to one or more embodiments of this aspect, the starting RB for the RB allocation in the at least one SBFD symbol is further based on a number of RBs for the RB allocation.

According to one or more embodiments of this aspect, a starting resource block allocated for the uplink transmission in the at least one SBFD symbol is determined based on a starting resource block of an UL subband of the at least one SBFD symbol.

According to one or more embodiments of this aspect, resource blocks of the uplink transmission allocated outside resource blocks of an UL subband of the at least one SBFD symbol are at least one of: dropped; and re-allocated to a subset of the resource blocks of the UL subband.

According to one aspect of the present disclosure, a method performed on a wireless device is provided. The method includes: receiving an control signaling for a physical uplink shared channel, PUSCH, transmission; and performing the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

According to one or more embodiments of this aspect, the control signaling includes a frequency hopping configuration.

According to one or more embodiments of this aspect, the control signaling includes an indication of a resource block, RB, allocation in a frequency domain for the at least one UL-only symbol, the indication including at least an indication of a starting RB for the RB allocation in the frequency domain for the at least one UL-only symbol.

According to one or more embodiments of this aspect, the indication further comprises an indication of a number of RBs for the RB allocation.

According to one or more embodiments of this aspect, the control signaling includes at least one of a higher layer configuration and a downlink control information, DCI, indication.

According to one or more embodiments of this aspect, the wireless device performs at least one of inter-slot frequency hopping and intra-slot frequency hopping in the at least one UL-only symbol; and the wireless device does not perform frequency hopping in the at least one SBFD symbol.

According to one or more embodiments of this aspect, the frequency hopping configuration includes a plurality of preconfigured frequency hopping offsets; and the wireless device is further configured to: perform at least one of inter-slot frequency hopping and intra-slot frequency hopping in the at least one UL-only symbol based on a first frequency hopping offset included in a first subset of the plurality of preconfigured frequency hopping offsets; and perform at least one of inter-slot frequency hopping and intra-slot frequency hopping in the at least one SBFD symbol based on a second frequency hopping offset included in a second subset of the plurality of preconfigured frequency hopping offsets.

According to one or more embodiments of this aspect, the frequency hopping configuration includes an SBFD frequency offset that is based on an UL subband size of the at least one SBFD symbol.

According to one or more embodiments of this aspect, the frequency hopping configuration includes an indication of a first frequency hopping offset used for frequency hopping in the at least one UL-only symbol and a second frequency hopping offset used for frequency hopping in the at least one SBFD symbol.

According to one or more embodiments of this aspect, the PUSCH transmission includes a plurality of allocated resource blocks, and the wireless device does not transmit PUSCH in the resource blocks in the at least one SBFD symbol based on some or all of the plurality of allocated resource blocks not being allocated within an UL subband of the at least one SBFD symbol.

According to one or more embodiments of this aspect, the PUSCH transmission includes a plurality of allocated resource blocks; a first portion of the allocated resource blocks being allocated within an UL subband of the at least one SBFD symbol; a second portion of the allocated resource blocks being allocated outside of the UL subband of the at least one SBFD symbol; and the wireless device transmits PUSCH in the first portion of the allocated resource blocks in the at least one SBFD symbol and does not transmit PUSCH in the second portion of the allocated resource blocks in the at least one SBFD symbol. According to one or more embodiments of this aspect, the PUSCH transmission is allocated resource blocks in the at least one SBFD symbol based on at least one of a subband size of an UL subband of the at least one SBFD symbol and a frequency domain location of the UL subband of the at least one SBFD symbol.

According to one or more embodiments of this aspect, the wireless device transmits PUSCH with or without frequency hopping based on an UL subband size of the at least one SBFD symbol being one of greater than or less than a threshold, respectively.

According to one or more embodiments of this aspect, the frequency hopping configuration includes a first frequency hopping offset used for at least one of inter-slot frequency hopping and intra-slot frequency hopping in the at least one UL-only symbol and at least one of a second and a third frequency hopping offset used for frequency hopping in the at least one SBFD symbol.

According to one or more embodiments of this aspect, each of the second and third frequency hopping offset is based on one of: a frequency domain location of a reference resource block in the at least one UL-only symbol; or a frequency domain location of a reference resource block within an UL subband of the at least one SBFD symbol.

According to one or more embodiments of this aspect at least one of the second and third frequency hopping offsets is at least one of: semi-statically configured; and implicitly determined by the wireless device based on at least one of the size and frequency domain location of an UL subband of the at least one SBFD symbol.

According to one or more embodiments of this aspect, a starting resource block, RB, for an RB allocation in the at least one SBFD symbol is based on at least the starting RB for the RB allocation in the frequency domain for the at least one UL-only symbol and at least one of the second and third frequency hopping offsets.

According to one or more embodiments of this aspect, a starting resource block, RB, for an RB allocation in the at least one SBFD symbol is based on at least a starting RB of an UL subband.

According to one or more embodiments of this aspect, the starting RB for the RB allocation in the at least one SBFD symbol is further based on at least one of the second and third frequency hopping offsets.

According to one or more embodiments of this aspect, the starting RB for the RB allocation in the at least one SBFD symbol is further based on the first frequency hopping offset.

According to one or more embodiments of this aspect, the starting RB for the RB allocation in the at least one SBFD symbol is further based on a UL subband size.

According to one or more embodiments of this aspect, the starting RB for the RB allocation in the at least one SBFD symbol is further based on a number of RBs for the RB allocation.

According to one or more embodiments of this aspect, a starting resource block allocated for the uplink transmission in the at least one SBFD symbol is determined based on a starting resource block of an UL subband of the at least one SBFD symbol.

According to one or more embodiments of this aspect, resource blocks of the uplink transmission allocated outside resource blocks of an UL subband of the at least one SBFD symbol are at least one of: dropped; and re-allocated to a subset of the resource blocks of the UL subband.

According to one aspect of the present disclosure a network node configured to communicate with a wireless device is provided. The network node is configured to: transmit, to the wireless device, an control signaling for a physical uplink shared channel, PUSCH, transmission; and receive the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

According to one or more embodiments of this aspect, the control signaling includes a frequency hopping configuration.

According to one or more embodiments of this aspect, the control signaling includes an indication of a resource block, RB, allocation in a frequency domain for the at least one UL-only symbol, the indication including at least an indication of a starting RB.

According to one or more embodiments of this aspect, the indication further comprises an indication of a number of RBs for the RB allocation.

According to one or more embodiments of this aspect, the control signaling includes at least one of a higher layer configuration and a downlink control information, DCI, indication.

According to one or more embodiments of this aspect, the wireless device performs at least one of inter-slot frequency hopping and intra-slot frequency hopping in the at least one UL-only symbol; and the wireless device does not perform frequency hopping in the at least one SBFD symbol.

According to one or more embodiments of this aspect, the frequency hopping configuration includes a plurality of preconfigured frequency hopping offsets; and the wireless device performs at least one of inter-slot frequency hopping and intra-slot frequency hopping in the at least one UL-only symbol based on a first frequency hopping offset included in a first subset of the plurality of preconfigured frequency hopping offsets; and the wireless device performs at least one of inter-slot frequency hopping and intra-slot frequency hopping in the at least one SBFD symbol based on a second frequency hopping offset included in a second subset of the plurality of preconfigured frequency hopping offsets.

According to one or more embodiments of this aspect, the frequency hopping configuration includes an SBFD frequency offset that is based on an UL subband size of the at least one SBFD symbol.

According to one or more embodiments of this aspect, the frequency hopping configuration includes an indication of a first frequency hopping offset used for frequency hopping in the at least one UL-only symbol and a second frequency hopping offset used for frequency hopping in the at least one SBFD symbol.

According to one or more embodiments of this aspect, the PUSCH transmission includes a plurality of allocated resource blocks, and the wireless device does not transmit PUSCH in the resource blocks in the at least one SBFD symbol based on some or all of the plurality of allocated resource blocks not being allocated within an UL subband of the at least one SBFD symbol.

According to one or more embodiments of this aspect, the PUSCH transmission includes a plurality of allocated resource blocks; a first portion of the allocated resource blocks being allocated within an UL subband of the at least one SBFD symbol; a second portion of the allocated resource blocks being allocated outside of the UL subband of the at least one SBFD symbol; and the wireless device transmits PUSCH in the first portion of the allocated resource blocks in the at least one SBFD symbol and does not transmit PUSCH in the second portion of the allocated resource blocks in the at least one SBFD symbol.

According to one or more embodiments of this aspect, the PUSCH transmission is allocated resource blocks in the at least one SBFD symbol based on at least one of a subband size of an UL subband of the at least one SBFD symbol and a frequency domain location of the UL subband of the at least one SBFD symbol.

According to one or more embodiments of this aspect, the wireless device transmits PUSCH with or without frequency hopping based on an UL subband size of the at least one SBFD symbol being one of greater than or less than a threshold, respectively.

According to one or more embodiments of this aspect, the frequency hopping configuration includes a first frequency hopping offset used for at least one of inter-slot frequency hopping and intra-slot frequency hopping in the at least one UL-only symbol and at least one of a second and a third frequency hopping offset used for frequency hopping in the at least one SBFD symbol.

According to one or more embodiments of this aspect, each of the second and third frequency hopping offset is based on one of: a frequency domain location of a reference resource block in the at least one UL-only symbol; or a frequency domain location of a reference resource block within an UL subband of the at least one SBFD symbol.

According to one or more embodiments of this aspect at least one of the second and third frequency hopping offsets is at least one of: semi-statically configured; and implicitly determined by the wireless device based on at least one of the size and frequency domain location of an UL subband of the at least one SBFD symbol.

According to one or more embodiments of this aspect, a starting resource block, RB, for an RB allocation in the at least one SBFD symbol is based on at least the starting RB for the RB allocation in the frequency domain for the at least one UL-only symbol and at least one of the second and third frequency hopping offsets.

According to one or more embodiments of this aspect, a starting resource block, RB, for an RB allocation in the at least one SBFD symbol is based on at least a starting RB of an UL subband.

According to one or more embodiments of this aspect, the starting RB for the RB allocation in the at least one SBFD symbol is further based on at least one of the second and third frequency hopping offsets.

According to one or more embodiments of this aspect, the starting RB for the RB allocation in the at least one SBFD symbol is further based on the first frequency hopping offset.

According to one or more embodiments of this aspect, the starting RB for the RB allocation in the at least one SBFD symbol is further based on a UL subband size.

According to one or more embodiments of this aspect, the starting RB for the RB allocation in the at least one SBFD symbol is further based on a number of RBs for the RB allocation.

According to one or more embodiments of this aspect, a starting resource block allocated for the uplink transmission in the at least one SBFD symbol is determined based on a starting resource block of an UL subband of the at least one SBFD symbol.

According to one or more embodiments of this aspect, resource blocks of the uplink transmission allocated outside resource blocks of an UL subband of the at least one SBFD symbol are at least one of: dropped; and re-allocated to a subset of the resource blocks of the UL subband.

According to one aspect of the present disclosure, a method performed on a network node is provided. The method includes: transmitting, to a wireless device, an control signaling for a physical uplink shared channel, PUSCH, transmission; and receiving the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

According to one or more embodiments of this aspect, the control signaling includes a frequency hopping configuration.

According to one or more embodiments of this aspect, the control signaling includes an indication of a resource block, RB, allocation in a frequency domain for the at least one UL-only symbol, the indication including at least an indication of a starting RB.

According to one or more embodiments of this aspect, the indication further comprises an indication of a number of RBs for the RB allocation.

According to one or more embodiments of this aspect, the control signaling includes at least one of a higher layer configuration and a downlink control information, DCI, indication.

According to one or more embodiments of this aspect, the wireless device performs at least one of inter-slot frequency hopping and intra-slot frequency hopping in the at least one UL-only symbol; and the wireless device does not perform frequency hopping in the at least one SBFD symbol.

According to one or more embodiments of this aspect, the frequency hopping configuration includes a plurality of preconfigured frequency hopping offsets; and the wireless device performs at least one of inter-slot frequency hopping and intra-slot frequency hopping in the at least one UL-only symbol based on a first frequency hopping offset included in a first subset of the plurality of preconfigured frequency hopping offsets; and the wireless device performs at least one of inter-slot frequency hopping and intra-slot frequency hopping in the at least one SBFD symbol based on a second frequency hopping offset included in a second subset of the plurality of preconfigured frequency hopping offsets.

According to one or more embodiments of this aspect, the frequency hopping configuration includes an SBFD frequency offset that is based on an UL subband size of the at least one SBFD symbol.

According to one or more embodiments of this aspect, the frequency hopping configuration includes an indication of a first frequency hopping offset used for frequency hopping in the at least one UL-only symbol and a second frequency hopping offset used for frequency hopping in the at least one SBFD symbol.

According to one or more embodiments of this aspect, the PUSCH transmission includes a plurality of allocated resource blocks, and the wireless device does not transmit PUSCH in the resource blocks in the at least one SBFD symbol based on some or all of the plurality of allocated resource blocks not being allocated within an UL subband of the at least one SBFD symbol.

According to one or more embodiments of this aspect, the PUSCH transmission includes a plurality of allocated resource blocks; a first portion of the allocated resource blocks being allocated within an UL subband of the at least one SBFD symbol; a second portion of the allocated resource blocks being allocated outside of the UL subband of the at least one SBFD symbol; and the wireless device transmits PUSCH in the first portion of the allocated resource blocks in the at least one SBFD symbol and does not transmit PUSCH in the second portion of the allocated resource blocks in the at least one SBFD symbol.

According to one or more embodiments of this aspect, the PUSCH transmission is allocated resource blocks in the at least one SBFD symbol based on at least one of a subband size of an UL subband of the at least one SBFD symbol and a frequency domain location of the UL subband of the at least one SBFD symbol.

According to one or more embodiments of this aspect, the wireless device transmits PUSCH with or without frequency hopping based on an UL subband size of the at least one SBFD symbol being one of greater than or less than a threshold, respectively.

According to one or more embodiments of this aspect, the frequency hopping configuration includes a first frequency hopping offset used for at least one of inter-slot frequency hopping and intra-slot frequency hopping in the at least one UL-only symbol and at least one of a second and a third frequency hopping offset used for frequency hopping in the at least one SBFD symbol.

According to one or more embodiments of this aspect, each of the second and third frequency hopping offset is based on one of: a frequency domain location of a reference resource block in the at least one UL-only symbol; or a frequency domain location of a reference resource block within an UL subband of the at least one SBFD symbol.

According to one or more embodiments of this aspect at least one of the second and third frequency hopping offsets is at least one of: semi-statically configured; and implicitly determined by the wireless device based on at least one of the size and frequency domain location of an UL subband of the at least one SBFD symbol.

According to one or more embodiments of this aspect, a starting resource block, RB, for an RB allocation in the at least one SBFD symbol is based on at least the starting RB for the RB allocation in the frequency domain for the at least one UL-only symbol and at least one of the second and third frequency hopping offsets.

According to one or more embodiments of this aspect, a starting resource block, RB, for an RB allocation in the at least one SBFD symbol is based on at least a starting RB of an UL subband.

According to one or more embodiments of this aspect, the starting RB for the RB allocation in the at least one SBFD symbol is further based on at least one of the second and third frequency hopping offsets.

According to one or more embodiments of this aspect, the starting RB for the RB allocation in the at least one SBFD symbol is further based on the first frequency hopping offset.

According to one or more embodiments of this aspect, the starting RB for the RB allocation in the at least one SBFD symbol is further based on a UL subband size.

According to one or more embodiments of this aspect, the starting RB for the RB allocation in the at least one SBFD symbol is further based on a number of RBs for the RB allocation.

According to one or more embodiments of this aspect, a starting resource block allocated for the uplink transmission in the at least one SBFD symbol is determined based on a starting resource block of an UL subband of the at least one SBFD symbol.

According to one or more embodiments of this aspect, resource blocks of the uplink transmission allocated outside resource blocks of an UL subband of the at least one SBFD symbol are at least one of: dropped; and re-allocated to a subset of the resource blocks of the UL subband.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example radio resource configuration in NR;

FIG. 2 illustrates an example configuration of a subframe with 14 OFDM symbols;

FIG. 3 illustrates example TDD and FDD configurations;

FIG. 4 illustrates example uplink/downlink time/frequency configuration for FDD and TDD;

FIG. 5 illustrates example TDD DL/UL pattern configurations;

FIG. 6A, FIG. 6B, and FIG. 6C illustrate example cell-specific TDD DL/UL configurations;

FIG. 7 illustrates example TDD carrier configurations;

FIG. 8 illustrates an example configuration for subband full duplex systems;

FIG. 9 illustrates example configurations of 3 RB sets in an SBFD symbol;

FIG. 10 illustrates a generic example antenna array for a TDD system;

FIG. 11 illustrates an example antenna architecture for SBFD systems;

FIG. 12 illustrates an example configuration N-bit FDRA field for PUSCH;

FIG. 13 illustrates an example configuration of inter-slot hopping for multi-slot PUSCH;

FIG. 14 illustrates an example configuration of intra-slot frequency hopping for PUSCH;

FIG. 15 is a schematic diagram of an example network architecture illustrating a communication system connected via an intermediate network to a host computer according to the principles in the present disclosure;

FIG. 16 is a block diagram of a host computer communicating via a network node with a wireless device over an at least partially wireless connection according to some embodiments of the present disclosure;

FIG. 17 is a flowchart illustrating example methods implemented in a communication system including a host computer, a network node and a wireless device for executing a client application at a wireless device according to some embodiments of the present disclosure;

FIG. 18 is a flowchart illustrating example methods implemented in a communication system including a host computer, a network node and a wireless device for receiving user data at a wireless device according to some embodiments of the present disclosure;

FIG. 19 is a flowchart illustrating example methods implemented in a communication system including a host computer, a network node and a wireless device for receiving user data from the wireless device at a host computer according to some embodiments of the present disclosure;

FIG. 20 is a flowchart illustrating example methods implemented in a communication system including a host computer, a network node and a wireless device for receiving user data at a host computer according to some embodiments of the present disclosure;

FIG. 21 is a flowchart of an example process in a network node for configuring an uplink channel for subband full duplex operation according to some embodiments of the present disclosure;

FIG. 22 is a flowchart of an example process in a wireless device for configuring an uplink channel for subband full duplex operation according to some embodiments of the present disclosure;

FIG. 23 is a flowchart of another example process in a network node according to some embodiments of the present disclosure;

FIG. 24 is a flowchart of another example process in a wireless device according to some embodiments of the present disclosure;

FIG. 25 is an illustration of an example configuration PUSCH configuration according to some embodiments of the present disclosure;

FIG. 26 is an illustration of another example PUSCH configuration according to some embodiments of the present disclosure; and

FIG. 27 is an illustration of another example PUSCH configuration according to some embodiments of the present disclosure.

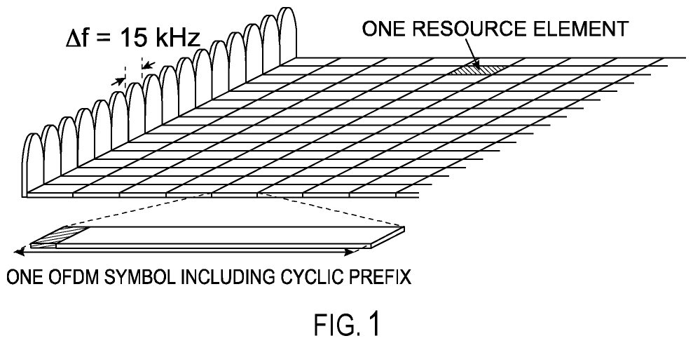

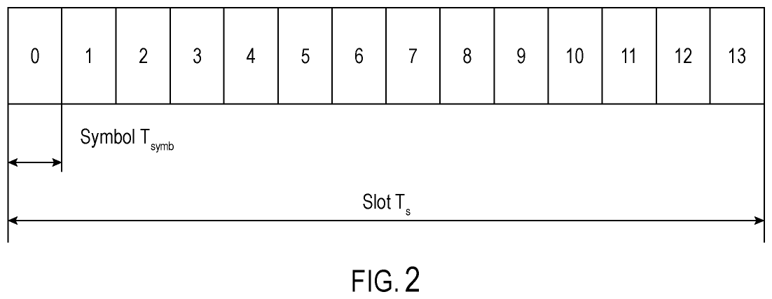

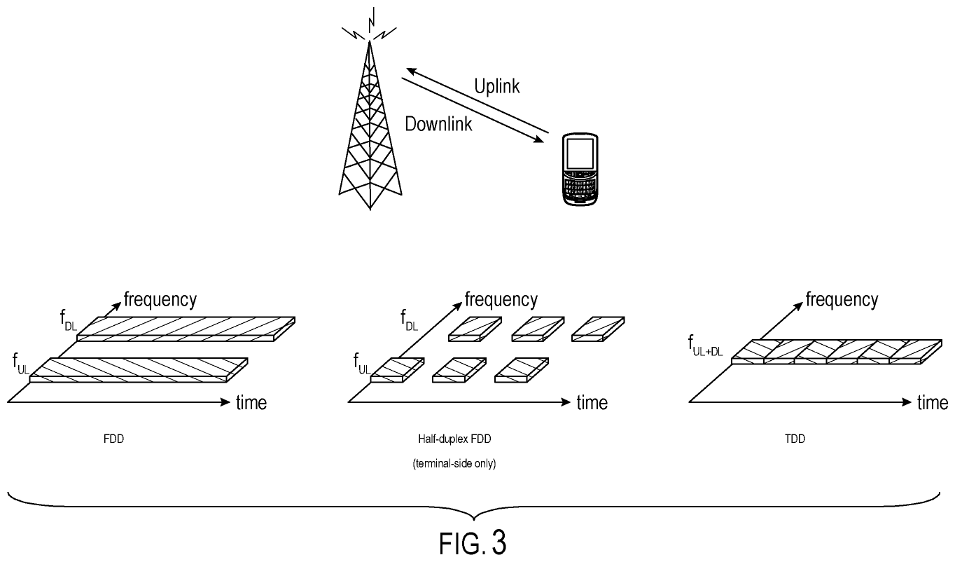

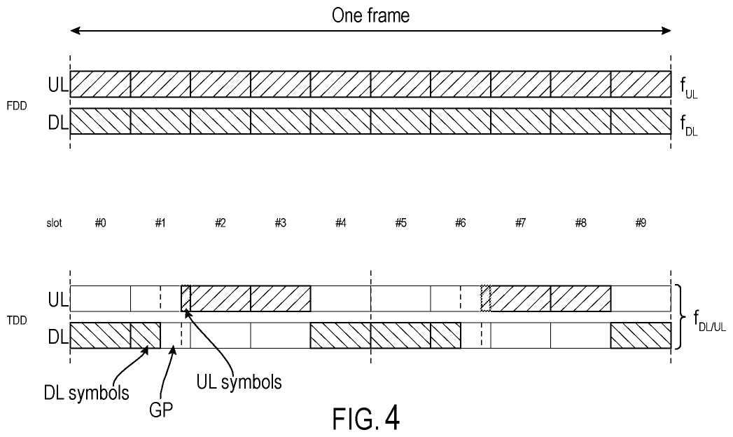

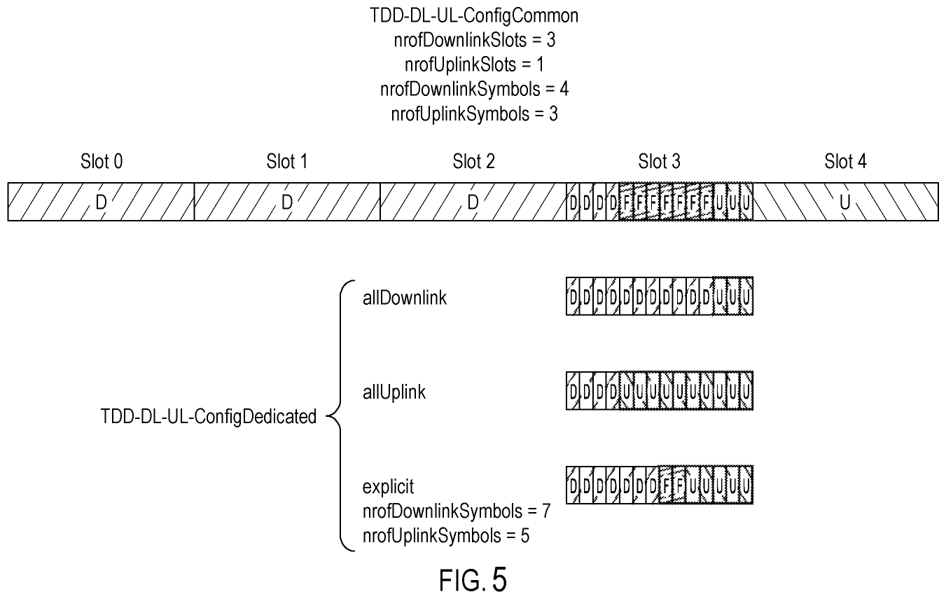

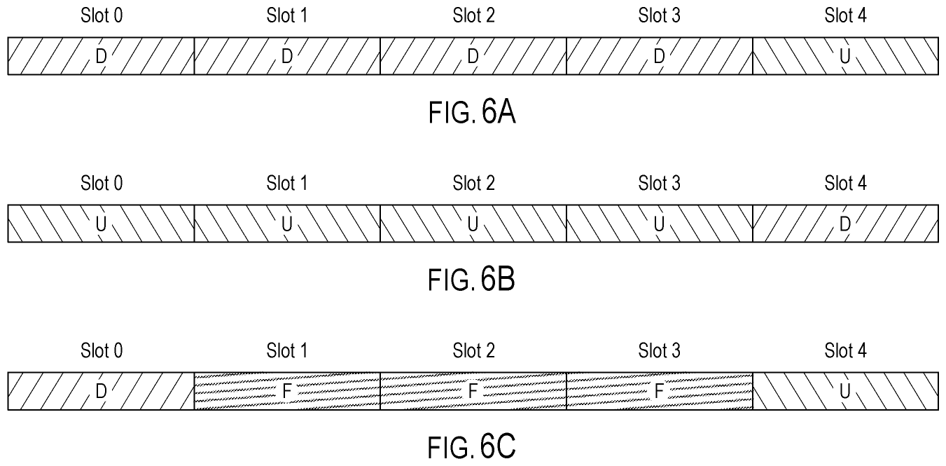

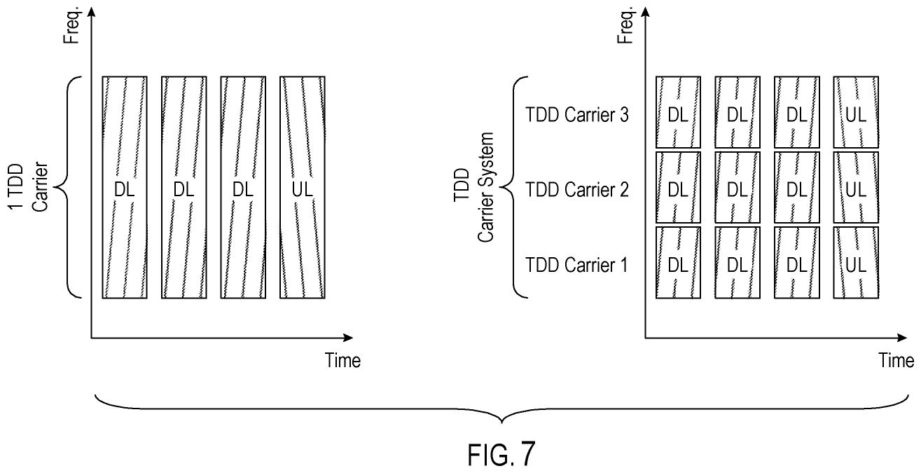

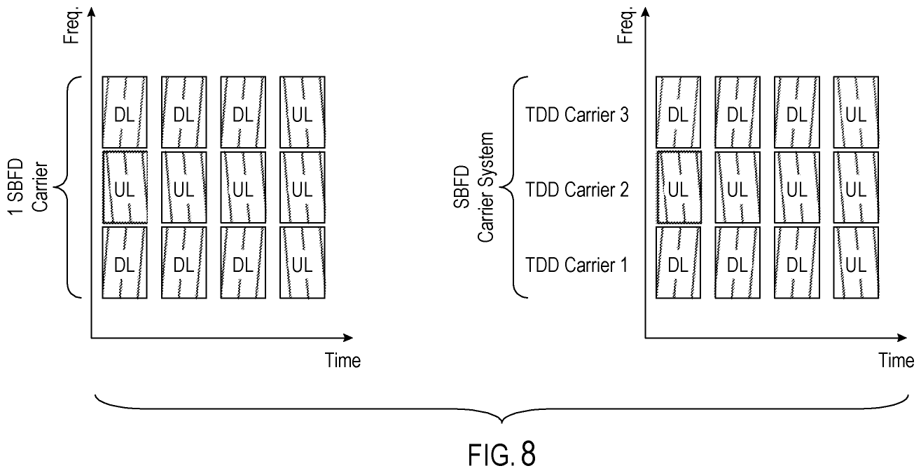

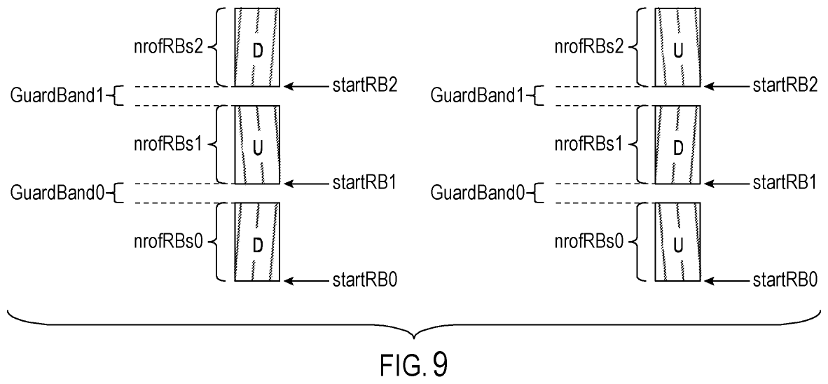

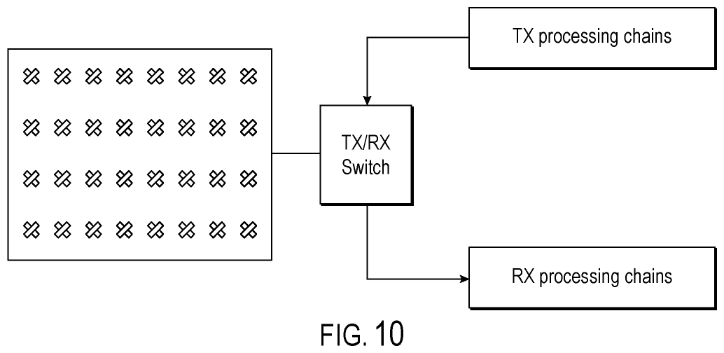

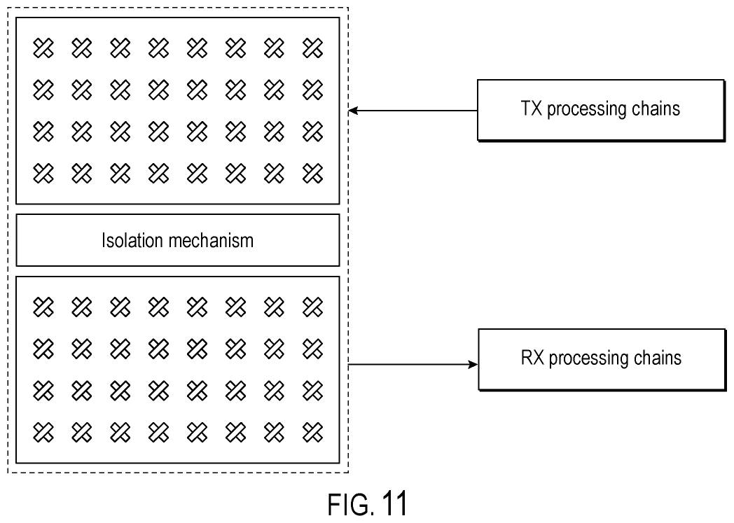

### DETAILED DESCRIPTION

Before describing in detail example embodiments, it is noted that the embodiments reside primarily in combinations of apparatus components and processing steps related to configuring an uplink channel for subband full duplex operation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible for achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide methods, systems, and apparatuses for configuring an uplink channel for subband full duplex operation.

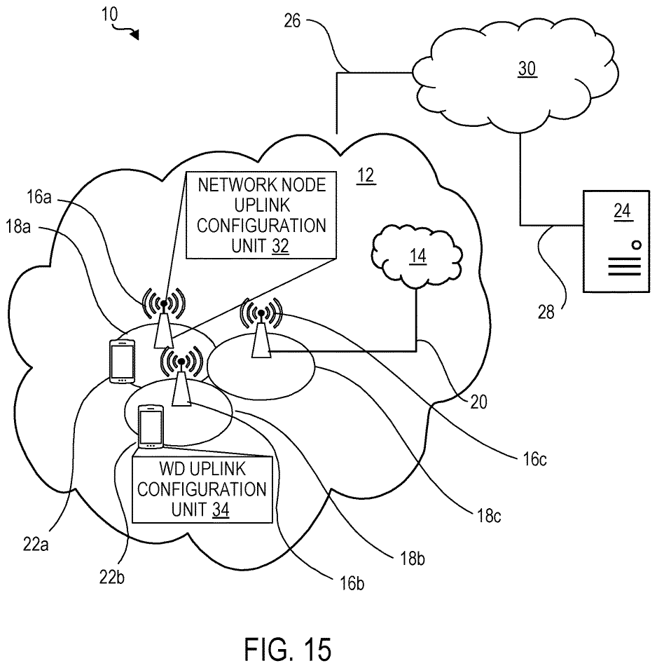

Referring again to the drawing figures, in which like elements are referred to by like reference numerals, there is shown in FIG. 15 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 15 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a Network Node Uplink Configuration Unit 32 which is configured for configuring an uplink channel for subband full duplex operation. A wireless device 22 is configured to include a Wireless Device Uplink Configuration 34 which is configured for configuring an uplink channel for subband full duplex operation.

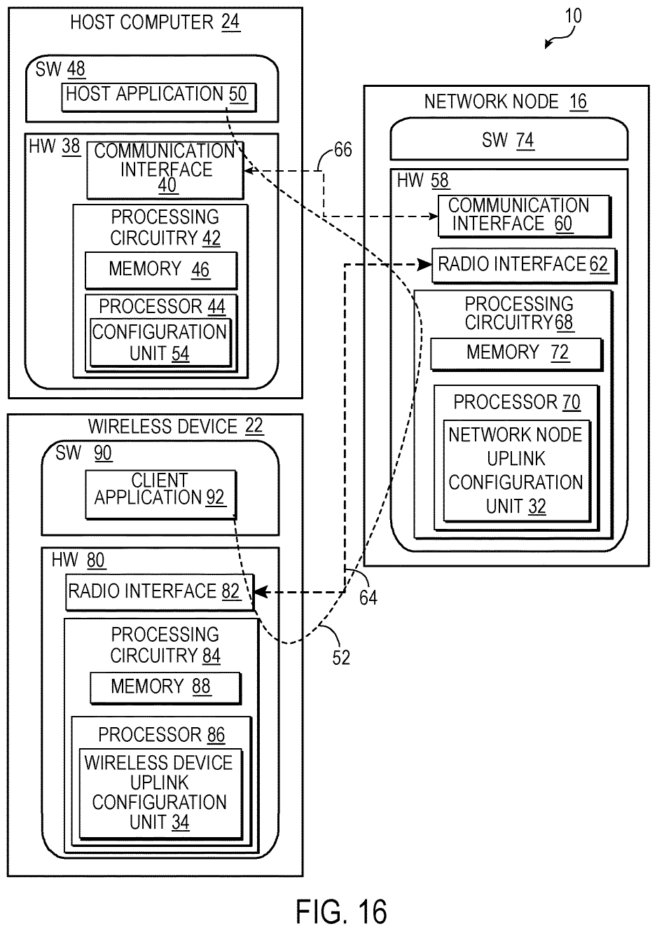

Example implementations, in accordance with an embodiment, of the WD 22, network node 16 and host computer 24 discussed in the preceding paragraphs will now be described with reference to FIG. 16. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Configuration Unit 54 configured to enable the service provider to observe/monitor/control/transmit to/receive from/etc. the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include Network Node Uplink Configuration Unit 32 configured for configuring an uplink channel for subband full duplex operation.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a Wireless Device Uplink Configuration Unit 34 configured for configuring an uplink channel for subband full duplex operation.

In some embodiments, the inner workings of the network node 16, WD 22, and host computer 24 may be as shown in FIG. 16 and independently, the surrounding network topology may be that of FIG. 15.

In FIG. 16, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 15 and 16 show various “units” such as Network Node Uplink Configuration Unit 32 and Wireless Device Uplink Configuration Unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

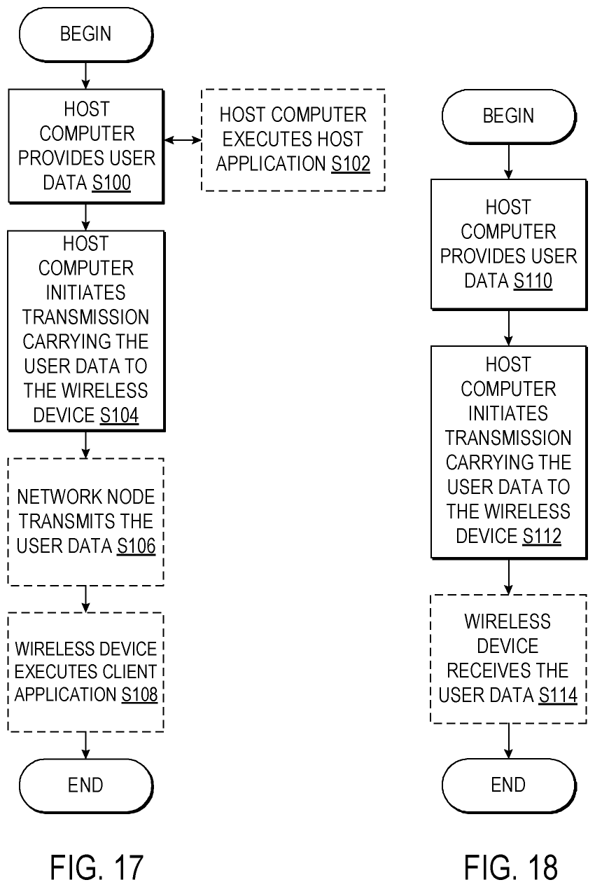

FIG. 17 is a flowchart illustrating an example method implemented in a communication system, such as, for example, the communication system of FIGS. 15 and 16, in accordance with one embodiment. The communication system may include a host computer 24, a network node 16 and a WD 22, which may be those described with reference to FIG. 16. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 18 is a flowchart illustrating an example method implemented in a communication system, such as, for example, the communication system of FIG. 15, in accordance with one embodiment. The communication system may include a host computer 24, a network node 16 and a WD 22, which may be those described with reference to FIGS. 15 and 16. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

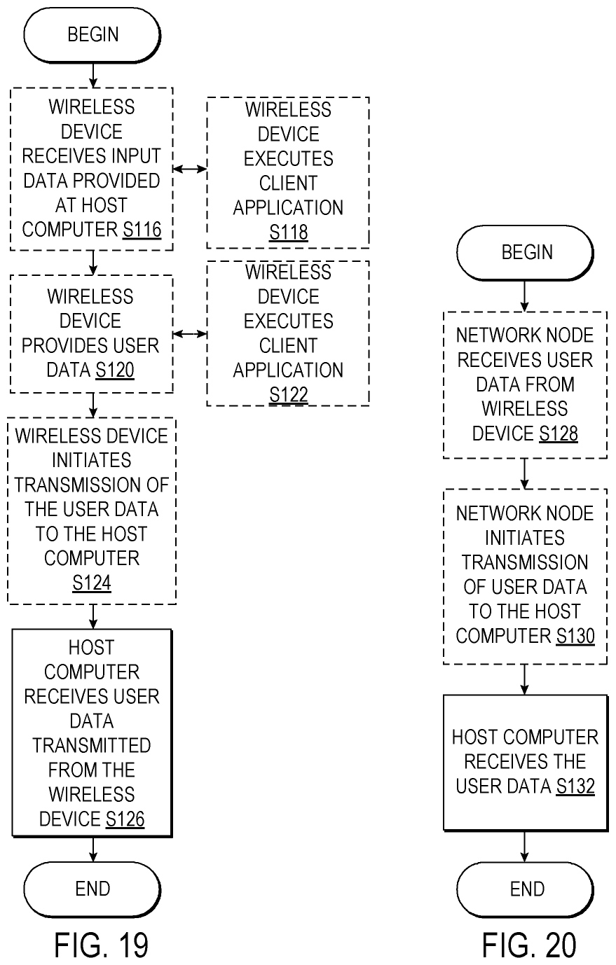

FIG. 19 is a flowchart illustrating an example method implemented in a communication system, such as, for example, the communication system of FIG. 15, in accordance with one embodiment. The communication system may include a host computer 24, a network node 16 and a WD 22, which may be those described with reference to FIGS. 15 and 16. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 20 is a flowchart illustrating an example method implemented in a communication system, such as, for example, the communication system of FIG. 15, in accordance with one embodiment. The communication system may include a host computer 24, a network node 16 and a WD 22, which may be those described with reference to FIGS. 15 and 16. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

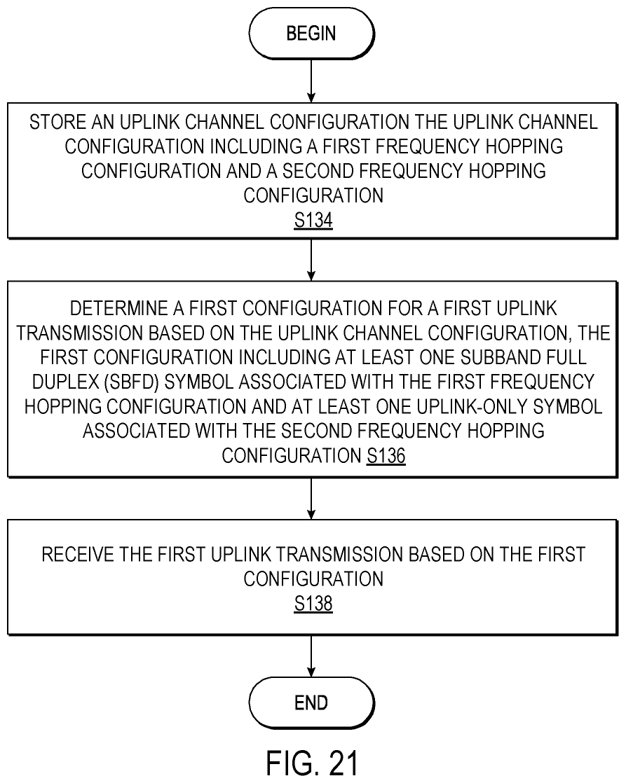

FIG. 21 is a flowchart of an example process in a network node 16 for configuring an uplink channel for subband full duplex operation. One or more blocks described herein may be performed by one or more elements of network node 16 such as by one or more of processing circuitry 68 (including the Network Node Uplink Configuration Unit 32), processor 70, radio interface 62 and/or communication interface 60. Network node 16 is configured to store (Block S134) an uplink channel configuration, the uplink channel configuration including a first frequency hopping configuration and a second frequency hopping configuration. Network node 16 is configured to determine (Block S136) a first configuration for a first uplink transmission based on the uplink channel configuration, where the first configuration includes at least one subband full duplex (SBFD) symbol associated with the first frequency hopping configuration and at least one uplink-only symbol associated with the second frequency hopping configuration. Network node 16 is configured to receive (Block S138) the first uplink transmission based on the first configuration.

In some embodiments, network node 16 is further configured to determine a first scheduling grant based on the first configuration and cause transmission of the first scheduling grant to the wireless device. The receiving of the first uplink transmission is further based on the first scheduling grant.

In some embodiments, the first frequency hopping configuration associated with the at least one SBFD symbol includes at least one of not applying frequency hopping to the at least one SBFD symbol, and applying a first set of frequency hopping offsets to the at least one SBFD symbol. The second frequency hopping configuration associated with the at least one uplink-only symbol includes at least one of applying frequency hopping to the at least one uplink-only symbol, and applying a second set of frequency hopping offsets to the at least one uplink-only symbol.

In some embodiments, the first set of frequency hopping offsets is determined based on an uplink bandwidth part size, and the second set of frequency hopping offsets is determined based on an uplink subband size.

In some embodiments, the determining of the first configuration further includes determining a plurality of allocated resource blocks (RB), and determining an uplink subband associated with the first uplink transmission. The allocated RBs are mapped to the at least one SBFD symbol is based on the allocated RBs being within the uplink subband, and/or the allocated RBs are adjusted based on a first RB offset, a starting RB of the adjusted allocated RBs being within the uplink subband.

In some embodiments, network node 16 is further configured to determine an uplink subband associated with the first uplink transmission. The first frequency hopping configuration associated with the at least one SBFD symbol includes not applying frequency hopping to the at least one SBFD symbol based on the uplink subband being smaller than a threshold associated with the uplink channel configuration.

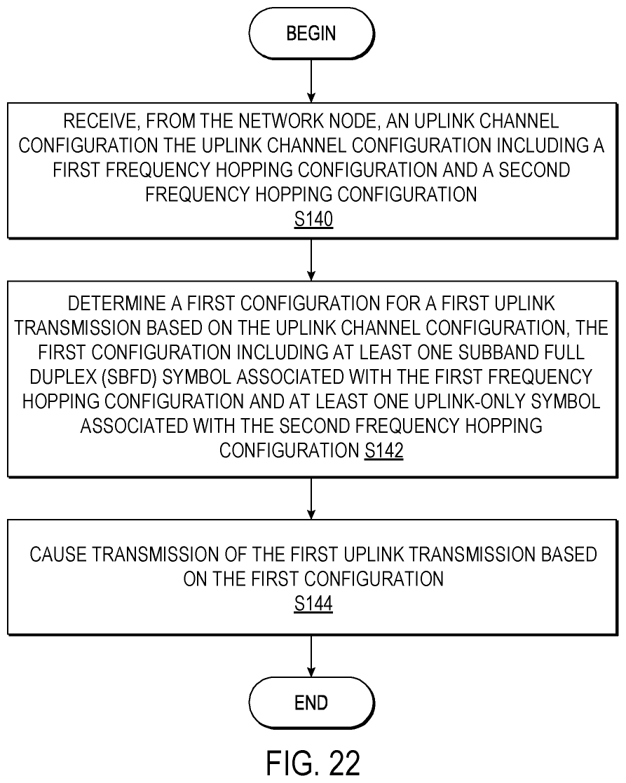

FIG. 22 is a flowchart of an example process in a wireless device 22 according to some embodiments of the present disclosure for configuring an uplink channel for subband full duplex operation. One or more blocks described herein may be performed by one or more elements of wireless device 22 such as by one or more of processing circuitry 84 (including the Wireless Device Uplink Configuration Unit 34), processor 86, radio interface 82 and/or communication interface 60. Wireless device 22 is configured to receive (Block S140), from the network node 16, an uplink channel configuration, the uplink channel configuration including a first frequency hopping configuration and a second frequency hopping configuration. Wireless device 22 is further configured to determine (Block S142) a first configuration for a first uplink transmission based on the uplink channel configuration, where the first configuration includes at least one subband full duplex (SBFD) symbol associated with the first frequency hopping configuration and at least one uplink-only symbol associated with the second frequency hopping configuration. Wireless device 22 is further configured to cause transmission (Block S144) of the first uplink transmission based on the first configuration.

In some embodiments, the wireless device 22 is further configured to receive a first scheduling grant from the network node 16, where the determining of the first configuration for the first uplink transmission is further based on the first scheduling grant.

In some embodiments, the first frequency hopping configuration associated with the at least one SBFD symbol includes at least one of not applying frequency hopping to the at least one SBFD symbol and applying a first set of frequency hopping offsets to the at least one SBFD symbol. The second frequency hopping configuration associated with the at least one uplink-only symbol includes at least one of applying frequency hopping to the at least one uplink-only symbol, and applying a second set of frequency hopping offsets to the at least one uplink-only symbol.

In some embodiments, the first set of frequency hopping offsets is determined based on an uplink bandwidth part size, and the second set of frequency hopping offsets is determined based on an uplink subband size.

In some embodiments, the determining of the first configuration further includes determining a plurality of allocated resource blocks (RB), determining an uplink subband associated with the first uplink transmission, and either the allocated RBs are mapped to the at least one SBFD symbol is based on the allocated RBs being within the uplink subband, or the allocated RBs are adjusted based on a first RB offset, where a starting RB of the adjusted allocated RBs is within the uplink subband.

In some embodiments, the wireless device 22 is further configured to determine an uplink subband associated with the first uplink transmission. The first frequency hopping configuration associated with the at least one SBFD symbol includes not applying frequency hopping to the at least one SBFD symbol based on the uplink subband being smaller than a threshold associated with the uplink channel configuration.

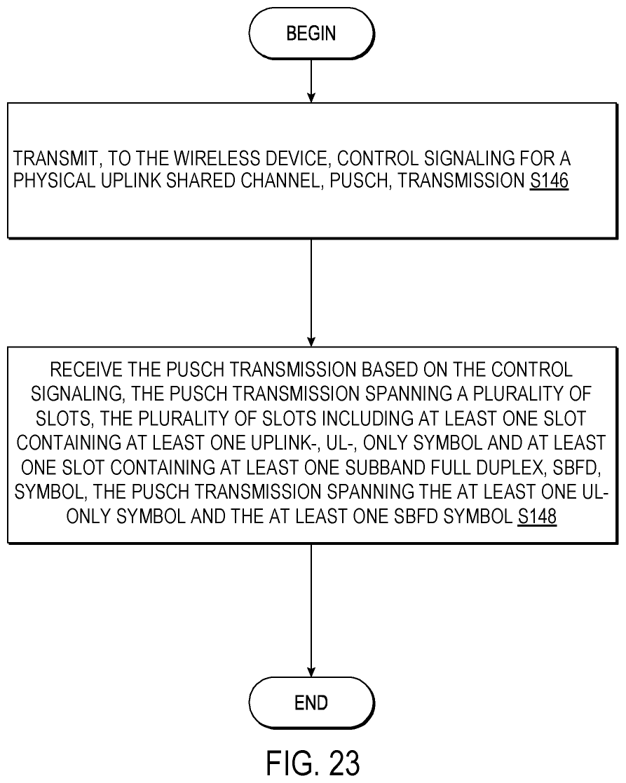

FIG. 23 is a flowchart of another example process in a network node 16 for configuring an uplink channel for subband full duplex operation. One or more blocks described herein may be performed by one or more elements of network node 16 such as by one or more of processing circuitry 68 (including the Network Node Uplink Configuration Unit 32), processor 70, radio interface 62 and/or communication interface 60. Network node 16 is configured to transmit (Block S146), to the wireless device 22, an control signaling for a physical uplink shared channel, PUSCH, transmission. Network node 16 is configured to receive (Block S148) the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

In some embodiments, the control signaling includes a frequency hopping configuration.

In some embodiments, the control signaling includes an indication of a resource block, RB, allocation in a frequency domain for the at least one UL-only symbol, the indication including at least an indication of a starting RB.

In some embodiments, the indication further comprises an indication of a number of RBs for the RB allocation.

In some embodiments, the control signaling includes at least one of a higher layer configuration and a downlink control information, DCI, indication.

In some embodiments, the wireless device 22 performs at least one of inter-slot frequency hopping and intra-slot frequency hopping in the at least one UL-only symbol; and the wireless device 22 does not perform frequency hopping in the at least one SBFD symbol.

In some embodiments, the frequency hopping configuration includes a plurality of preconfigured frequency hopping offsets; and the wireless device 22 performs at least one of inter-slot frequency hopping and intra-slot frequency hopping in the at least one UL-only symbol based on a first frequency hopping offset included in a first subset of the plurality of preconfigured frequency hopping offsets; and the wireless device 22 performs at least one of inter-slot frequency hopping and intra-slot frequency hopping in the at least one SBFD symbol based on a second frequency hopping offset included in a second subset of the plurality of preconfigured frequency hopping offsets.

In some embodiments, the frequency hopping configuration includes an SBFD frequency offset that is based on an UL subband size of the at least one SBFD symbol.

In some embodiments, the frequency hopping configuration includes an indication of a first frequency hopping offset used for frequency hopping in the at least one UL-only symbol and a second frequency hopping offset used for frequency hopping in the at least one SBFD symbol.

In some embodiments, the PUSCH transmission includes a plurality of allocated resource blocks, and the wireless device 22 does not transmit PUSCH in the resource blocks in the at least one SBFD symbol based on some or all of the plurality of allocated resource blocks not being allocated within an UL subband of the at least one SBFD symbol.

In some embodiments, the PUSCH transmission includes a plurality of allocated resource blocks; a first portion of the allocated resource blocks being allocated within an UL subband of the at least one SBFD symbol; a second portion of the allocated resource blocks being allocated outside of the UL subband of the at least one SBFD symbol; and the wireless device 22 transmits PUSCH in the first portion of the allocated resource blocks in the at least one SBFD symbol and does not transmit PUSCH in the second portion of the allocated resource blocks in the at least one SBFD symbol.

In some embodiments, the PUSCH transmission is allocated resource blocks in the at least one SBFD symbol based on at least one of a subband size of an UL subband of the at least one SBFD symbol and a frequency domain location of the UL subband of the at least one SBFD symbol.

In some embodiments, the wireless device 22 transmits PUSCH with or without frequency hopping based on an UL subband size of the at least one SBFD symbol being one of greater than or less than a threshold, respectively.

In some embodiments, the frequency hopping configuration includes a first frequency hopping offset used for at least one of inter-slot frequency hopping and intra-slot frequency hopping in the at least one UL-only symbol and at least one of a second and a third frequency hopping offset used for frequency hopping in the at least one SBFD symbol.

In some embodiments, each of the second and third frequency hopping offset is based on one of: a frequency domain location of a reference resource block in the at least one UL-only symbol; or a frequency domain location of a reference resource block within an UL subband of the at least one SBFD symbol.

In some embodiments, at least one of the second and third frequency hopping offsets is at least one of: semi-statically configured; and implicitly determined by the wireless device based on at least one of the size and frequency domain location of an UL subband of the at least one SBFD symbol.

In some embodiments, a starting resource block, RB, for an RB allocation in the at least one SBFD symbol is based on at least the starting RB for the RB allocation in the frequency domain for the at least one UL-only symbol and at least one of the second and third frequency hopping offsets.

In some embodiments, a starting resource block, RB, for an RB allocation in the at least one SBFD symbol is based on at least a starting RB of an UL subband.

In some embodiments, the starting RB for the RB allocation in the at least one SBFD symbol is further based on at least one of the second and third frequency hopping offsets.

In some embodiments, the starting RB for the RB allocation in the at least one SBFD symbol is further based on the first frequency hopping offset.

In some embodiments, the starting RB for the RB allocation in the at least one SBFD symbol is further based on a UL subband size.

In some embodiments, the starting RB for the RB allocation in the at least one SBFD symbol is further based on a number of RBs for the RB allocation.

In some embodiments, a starting resource block allocated for the uplink transmission in the at least one SBFD symbol is determined based on a starting resource block of an UL subband of the at least one SBFD symbol.

In some embodiments, resource blocks of the uplink transmission allocated outside resource blocks of an UL subband of the at least one SBFD symbol are at least one of: dropped; and re-allocated to a subset of the resource blocks of the UL subband.

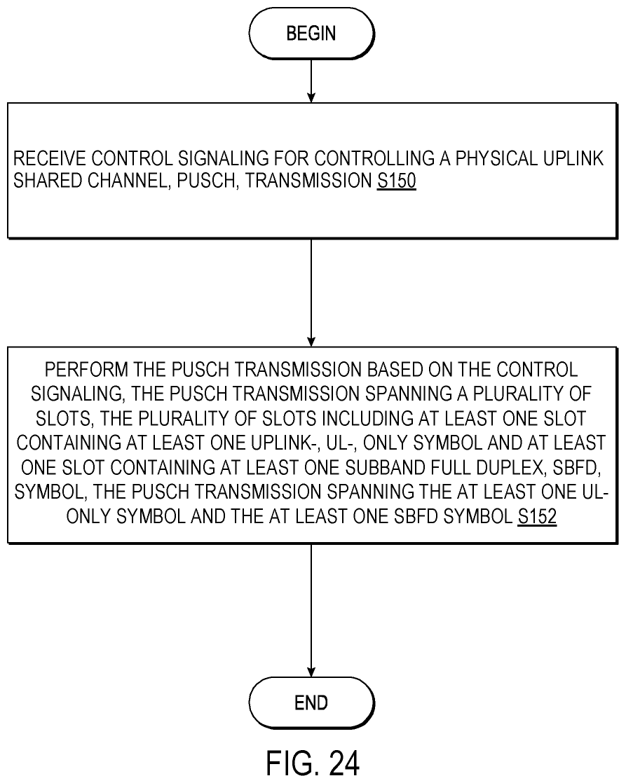

FIG. 24 is a flowchart of another example process in a wireless device 22 according to some embodiments of the present disclosure for configuring an uplink channel for subband full duplex operation. One or more blocks described herein may be performed by one or more elements of wireless device 22 such as by one or more of processing circuitry 84 (including the Wireless Device Uplink Configuration Unit 34), processor 86, radio interface 82 and/or communication interface 60. Wireless device 22 is configured to receive (Block S150) an control signaling for a physical uplink shared channel, PUSCH, transmission. Wireless device 22 is configured to perform (Block S152) the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

In some embodiments, the control signaling includes a frequency hopping configuration.

In some embodiments, the control signaling includes an indication of a resource block, RB, allocation in a frequency domain for the at least one UL-only symbol, the indication including at least an indication of a starting RB.

In some embodiments, the indication further comprises an indication of a number of RBs for the RB allocation.

In some embodiments, the control signaling includes at least one of a higher layer configuration and a downlink control information, DCI, indication.

In some embodiments, the wireless device 22 performs at least one of inter-slot frequency hopping and intra-slot frequency hopping in the at least one UL-only symbol; and the wireless device 22 does not perform frequency hopping in the at least one SBFD symbol.

In some embodiments, the frequency hopping configuration includes a plurality of preconfigured frequency hopping offsets; and the wireless device 22 is further configured to: perform at least one of inter-slot frequency hopping and intra-slot frequency hopping in the at least one UL-only symbol based on a first frequency hopping offset included in a first subset of the plurality of preconfigured frequency hopping offsets; and perform at least one of inter-slot frequency hopping and intra-slot frequency hopping in the at least one SBFD symbol based on a second frequency hopping offset included in a second subset of the plurality of preconfigured frequency hopping offsets.

In some embodiments, the frequency hopping configuration includes an SBFD frequency offset that is based on an UL subband size of the at least one SBFD symbol.

In some embodiments, the frequency hopping configuration includes an indication of a first frequency hopping offset used for frequency hopping in the at least one UL-only symbol and a second frequency hopping offset used for frequency hopping in the at least one SBFD symbol.

In some embodiments, the PUSCH transmission includes a plurality of allocated resource blocks, and the wireless device 22 does not transmit PUSCH in the resource blocks in the at least one SBFD symbol based on some or all of the plurality of allocated resource blocks not being allocated within an UL subband of the at least one SBFD symbol.

In some embodiments, the PUSCH transmission includes a plurality of allocated resource blocks; a first portion of the allocated resource blocks being allocated within an UL subband of the at least one SBFD symbol; a second portion of the allocated resource blocks being allocated outside of the UL subband of the at least one SBFD symbol; and the wireless device 22 transmits PUSCH in the first portion of the allocated resource blocks in the at least one SBFD symbol and does not transmit PUSCH in the second portion of the allocated resource blocks in the at least one SBFD symbol.

In some embodiments, the PUSCH transmission is allocated resource blocks in the at least one SBFD symbol based on at least one of a subband size of an UL subband of the at least one SBFD symbol and a frequency domain location of the UL subband of the at least one SBFD symbol.

In some embodiments, the wireless device 22 transmits PUSCH with or without frequency hopping based on an UL subband size of the at least one SBFD symbol being one of greater than or less than a threshold, respectively.

In some embodiments, the frequency hopping configuration includes a first frequency hopping offset used for at least one of inter-slot frequency hopping and intra-slot frequency hopping in the at least one UL-only symbol and at least one of a second and a third frequency hopping offset used for frequency hopping in the at least one SBFD symbol.

In some embodiments, each of the second and third frequency hopping offset is based on one of: a frequency domain location of a reference resource block in the at least one UL-only symbol; or a frequency domain location of a reference resource block within an UL subband of the at least one SBFD symbol.

In some embodiments, at least one of the second and third frequency hopping offsets is at least one of: semi-statically configured; and implicitly determined by the wireless device based on at least one of the size and frequency domain location of an UL subband of the at least one SBFD symbol.

In some embodiments, a starting resource block, RB, for an RB allocation in the at least one SBFD symbol is based on at least the starting RB for the RB allocation in the frequency domain for the at least one UL-only symbol and at least one of the second and third frequency hopping offsets.

In some embodiments, a starting resource block, RB, for an RB allocation in the at least one SBFD symbol is based on at least a starting RB of an UL subband.

In some embodiments, the starting RB for the RB allocation in the at least one SBFD symbol is further based on at least one of the second and third frequency hopping offsets.

In some embodiments, the starting RB for the RB allocation in the at least one SBFD symbol is further based on the first frequency hopping offset.

In some embodiments, the starting RB for the RB allocation in the at least one SBFD symbol symbol is further based on a UL subband size.

In some embodiments, the starting RB for the RB allocation in the at least one SBFD symbol is further based on a number of RBs for the RB allocation.

In some embodiments, a starting resource block allocated for the uplink transmission in the at least one SBFD symbol is determined based on a starting resource block of an UL subband of the at least one SBFD symbol.

In some embodiments, resource blocks of the uplink transmission allocated outside resource blocks of an UL subband of the at least one SBFD symbol are at least one of: dropped; and re-allocated to a subset of the resource blocks of the UL subband.

Having described the general process flow of arrangements of the disclosure and having provided examples of hardware and software arrangements for implementing the processes and functions of the disclosure, the sections below provide details and examples of arrangements for configuring an uplink channel for subband full duplex operation.

One or more network node 16 functions described below may be performed by one or more of processing circuitry 68, processor 70, network node uplink configuration unit 32, radio interface 62, etc. One or more wireless device 22 functions described below may be performed by one or more of processing circuitry 84, processor 86, wireless device uplink configuration unit 34, radio interface 82, etc.

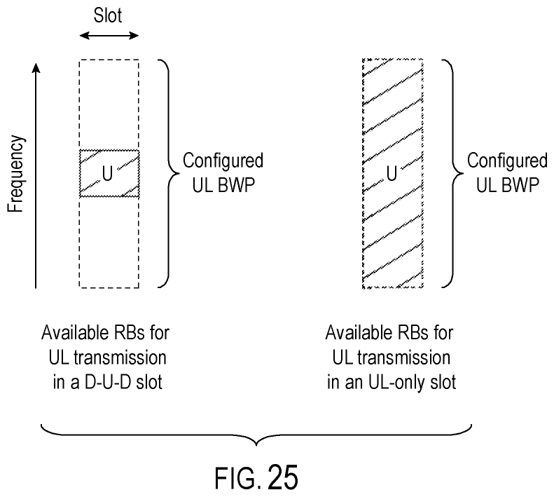

In one or more of the following embodiments, an SBFD symbol may refer to a symbol that is configured such that it can be used for SBFD operation, i.e., simultaneous network node 16 (e.g., gNB) transmission/reception within the same carrier. For example, an SBFD symbol may contain two ‘D’ frequency subbands (RB sets) and one ‘U’ subband (RB set) in the middle of the carrier-a so-called D-U-D configuration. In contrast, an UL-only symbol may refer to a symbol in which can only be used for wireless device 22 transmission within the carrier. FIG. 25 illustrates an example configuration of available RBs for UL transmission within the UL BWP for SBFD symbols and UL-only symbols. The two symbol types are illustrated in FIG. 25 where the number of RBs available for PUSCH is different in the SBFD symbols compared to the UL-only symbols.

In some of the embodiments below, it is generally understood that a scheduled or configured PUSCH can be either within a single slot or can occupy multiple slots, i.e., PUSCH with repetition. In SBFD operation, a multi-slot PUSCH may span different symbol types, i.e., one repetition in a slot with UL-only symbols, and another repetition in a slot with SBFD symbols.

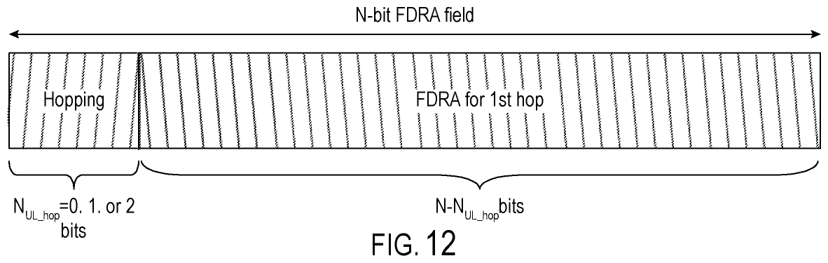

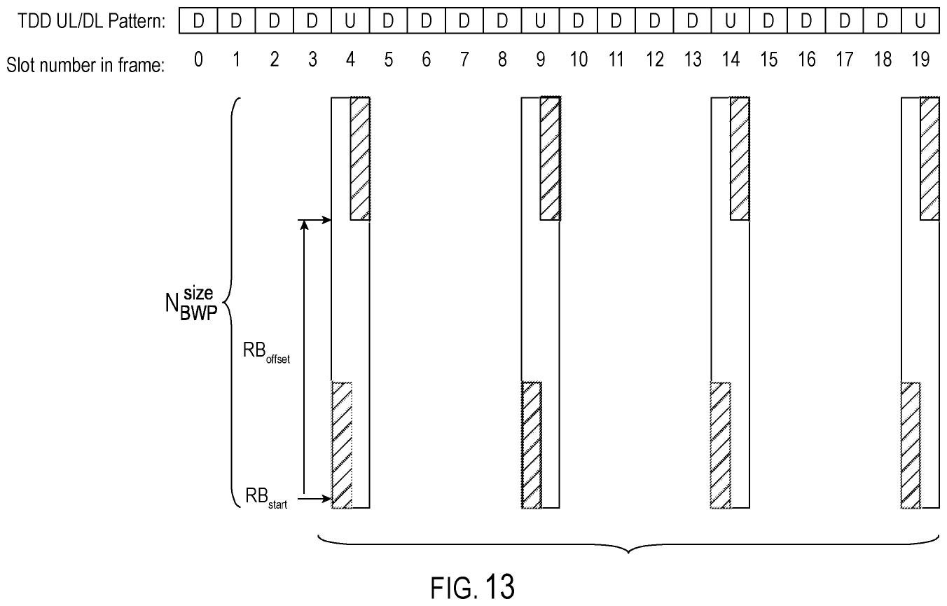

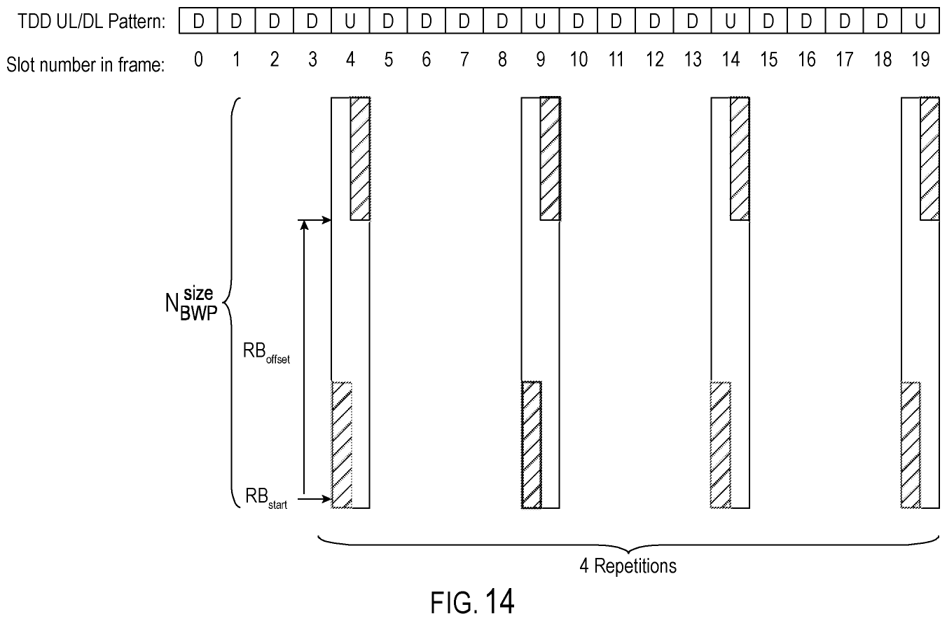

In referring to some of the below embodiments, the “the FDRA field, e.g., of an NR system, for a PUSCH transmission,” may refer to a field in a DCI or RAR UL grant that jointly indicates the RB offset for frequency hopping (if enabled)+the RBs allocated for PUSCH, e.g., as in the example illustrated in FIG. 12.

In describing some of the below embodiments, the present disclosure may use a non-limiting example system configuration for illustration, such as:
The UL BWP size

$${N}_{B W P}^{s i z e} = 273 RBs ;$$

The UL subband size

$${N}_{ULsubband}^{s i z e} = 51 RBs ;$$

The first UL subband RB index within the BWP is

$$R {B}_{s t a r t}^{U L s ubband} = 111 ;$$

and
The last UL subband RB index within the BWP is

$${RB}_{end}^{U L s ubband} = R {B}_{s t a r t}^{U L s ubband} + {N}_{U L s ubband}^{s i z e} - 1 = 161.$$

### SOME EXAMPLE EMBODIMENTS

### Embodiment Group A (Frequency Hopping Offset Determination)

Embodiment A1. In this embodiment, the wireless device 22 does not employ frequency hopping for a scheduled PUSCH transmission in SBFD symbols. That is, for a PUSCH scheduled by DCI or a RAR UL grant, the wireless device 22 ignores the N_{UL_hop} bits of the FDRA field for a PUSCH transmission in a mixed direction slot. This is because typical

$${N}_{UL subband}^{s i z e}$$

is much less than

$${N}_{B W P}^{s i z e}$$

and the potential frequency diversity in the UL subband may be much less than in the full BWP during UL-only symbols. For the case of a Type-1 configured grant PUSCH configured with frequency hopping, the wireless device 22 ignores the frequency hopping configuration for a PUSCH transmission in SBFD symbols.

Embodiment A2. In this embodiment, the wireless device 22 interprets the N_{UL_hop} bits of the FDRA field to select a frequency hopping offset differently based on whether a scheduled PUSCH transmission is in UL-only symbols or in SBFD symbols.

In a first nonlimiting example of Embodiment A2, the wireless device 22 may be configured with at least two sets of frequencyHoppingOffsetLists such that one set contains frequency hopping offsets to be applied in UL-only symbols and a different set contains frequency hopping offsets to be applied in SBFD symbols.

In a second nonlimiting example practice of Embodiment A2, the wireless device 22 may be configured with a frequency HoppingOffsetLists that is larger than needed, e.g., in an NR system. The wireless device 22 may select the frequency hopping offset based on at least the N_{UL_hop} bit field in the FDRA field and whether a scheduled PUSCH transmission is in UL-only or in SBFD symbols.

For instance, if N_{UL_hop}=1, the wireless device 22 selects frequency hopping offset from a frequency HoppingOffsetLists of two entries, e.g., in an NR system. However, for a cell 18 operating with both UL-only and SBFD symbols, the wireless device 22 may be configured with a list of four entries as illustrated in Table 2 below even when there is only N_{UL_hop}=1 bit for selecting the frequency hopping offset. For a scheduled PUSCH transmission in UL-only symbols, the wireless device 22 selects the frequency hopping offset from the first two entries. For a scheduled PUSCH transmission in SBFD symbols, the wireless device 22 may select the frequency hopping offset from the third and fourth entries.

TABLE 2

| Value of N_{UL, hop} Hopping | Frequency offsets for 2^{nd} hop in |
|---|---|
| bits | frequencyHoppingOffsetLists |
| 0 | RB offset value 0 (for UL-only |
| | symbols) |
| 1 | RB offset value 1 (for UL-only |
| | symbols |
| 0 | RB offset value 2 (for SBFD symbols) |
| 1 | RB offset value 3 (for SBFD symbols) |

Embodiment A3. In this embodiment, for PUSCH scheduled by RAR UL grant or PUSCH scheduled by DCI 0_0 with CRC scrambled by TC-RNTI, the wireless device 22 determines the frequency hopping offset differently based on at least whether a scheduled PUSCH transmission is in UL-only or in SBFD symbols.

In a first nonlimiting example of Embodiment A3, the wireless device 22 interprets the table (e.g., a default table, as defined in an NR standard) of frequency offsets differently based on whether a scheduled PUSCH transmission is in UL-only or SBFD symbols. In one nonlimiting example of the embodiment, the wireless device 22 determines the frequency hopping offset for a scheduled PUSCH transmissions in SBFD symbols by substituting

$${N}_{B W P}^{s i z e}$$

in the example of table 3 shown below shown with

$${N}_{U L s ubband}^{s i z e} .$$

For a scheduled PUSCH transmission in UL-only symbols, a “default” table may be used as is.

TABLE 3

| Number of PRBs | Value of N_{UL,hop} | Frequency offset |
|---|---|---|
| in UL Subband | Hopping Bits | for 2^{nd} hop |
| ${N}_{BWP}^{s i z e} < 50$ | 0 | $⌊ {N}_{BWP}^{s i z e} / 2 ⌋$ |
| | 1 | $⌊ {N}_{BWP}^{s i z e} / 4 ⌋$ |
| ${N}_{BWP}^{s i z e} \geq 50$ | 00 | $⌊ {N}_{BWP}^{s i z e} / 2 ⌋$ |
| | 01 | $⌊ {N}_{BWP}^{s i z e} / 4 ⌋$ |
| | 10 | $- ⌊ {N}_{BWP}^{s i z e} / 4 ⌋$ |
| | 11 | Reserved |

In a second nonlimiting example, the wireless device 22 may select the frequency hopping offset from a first default table for a scheduled PUSCH transmission in UL-only symbols (e.g., Table 3) and from a second default table for a scheduled PUSCH transmission in SBFD symbols. Said second table may be preconfigured in wireless device 22 and/or provided from the network node 16, e.g., via system information transmissions.

Embodiment A4. In this embodiment, for configured grant PUSCH of Type-1 where the FDRA field does not contain N_{UL_hop} bits to indicate a frequency hopping offset, if frequency hopping is configured, the wireless device 22 is further configured with two frequency hopping offset values such that the first value is applied in UL-only symbols and the second value is applied in SBFD symbols.

### Embodiment Group B (Based on Overlapping FDRA)

For this group of embodiments, the PUSCH FDRA field is interpreted according to existing NR systems/specifications for a PUSCH transmission in UL-only symbols.

Embodiment B1. In this embodiment, the wireless device 22 performs a PUSCH transmission in SBFD symbols only if the allocated RBs all fall within the UL subband.

For instance, a PUSCH allocated for RB #121 to RB #124 is transmitted in SBFD symbols since RBs are part of the UL subband.

However, a PUSCH allocated for RB #10 to RB #13 is not transmitted in SBFD symbols since these RBs are not part of the UL subband.

Embodiment B2. In this embodiment, the wireless device 22 adjusts the RB allocation of the PUSCH in SBFD symbols according to the available RBs in the UL subband. Only those that fall in the UL subband may be utilized for the PUSCH transmission in SBFD symbols by the wireless device 22. As a result of said adjustment, the channel coding rate of the PUSCH may become higher than that indicated in the scheduling DCI.

For instance, a PUSCH allocated for RB #121 to RB #124 is transmitted in SBFD symbols in all four RBs since the RBs are part of the UL subband.

However, a PUSCH allocated for RB #109 to RB #112 is transmitted in SBFD symbols with only two RBs (RB #111 and RB #112) since only these two RBs are part of the UL subband.

A PUSCH allocated for RB #10 to RB #13 is not transmitted in SBFD symbols since these RBs are not part of the UL subband.

Embodiment B3. In this embodiment, the wireless device 22 uses one of the embodiments from Group A Embodiments to determine the frequency hopping offset RB offset. For a PUSCH transmission in SBFD symbols, the wireless device 22 computes the PUSCH transmission starting RB index as follows for inter-slot hopping, e.g.:

$$R {B}_{s t a r t} ( {n}_{s , f}^{μ} ) = \{ \begin{matrix}R {B}_{s t a r t} & {n}_{s , f}^{μ} mod 2 = 0 \\ \begin{matrix}{RB}_{s t a r t}^{ULsubband} + [ ( R {B}_{s t a r t} - \\ {RB}_{s t a r t}^{ULsubband} + {RB}_{offset} ) mod {N}_{ULsubband}^{s i z e} ]\end{matrix} & {n}_{s , f}^{μ} mod 2 = 1\end{matrix}$$

As with Embodiment B2, only those RBs falling in the UL subband may be utilized for the PUSCH transmission in SBFD symbols by the wireless device 22.

For instance, a PUSCH allocated for RB #121 to RB #124 and a frequency hopping offset of

$$R {B}_{offset} = ⌊ {N}_{ULsubband}^{s i z e} / 2 ⌋ = 25$$

may be transmitted in SBFD symbols in the following RBs:
In even slots, the wireless device 22 transmits the PUSCH in RB #121 to RB #124;
In odd slots, the wireless device 22 transmits the PUSCH in RB #146 to RB #149;
   The starting RB index may be computed according to the above formula: 111+ [(121-111+25) mod 51]=111+35=146.

As another example, a PUSCH is allocated for RB #121 to RB #140 (i.e., 20 RBs in total) and a frequency hopping offset of

$${RB}_{offset} = ⌊ {N}_{ULsubband}^{s i z e} / 2 ⌋ = 25$$

is transmitted in SBFD symbols in the following RBs:
In even slots, the wireless device 22 transmits the PUSCH in RB #121 to RB #140 (i.e., 20 RBs in total).
In odd slots, the wireless device 22 transmits the PUSCH in RB #145 to RB #161 (i.e., 17 RBs in total).
   The starting RB index is computed as in the first example. If the UL subband is large enough, then the PUSCH would be transmitted in RB #146 to RB #164. However, the last RBs are outside of the UL subband and hence are not available. According to the teaching of the embodiment, the wireless device 22 transmits the PUSCH only in RB #146 to RB #161.

In a variation of the this embodiment, the wireless device 22 performs intra-slot hopping, and for a PUSCH transmission in SBFD symbols, the wireless device 22 computes the PUSCH transmission starting RB index, e.g., as follows:

$$R {B}_{s t a r t} ( i ) = \{ \begin{matrix}{RB}_{s t a r t} & i = 0 \\ ( {RB}_{s t a r t}^{ULsubband} + [ ( {RB}_{start} - R {B}_{start}^{ULsubband} + {RB}_{offset} ) mod {N}_{ULsubband}^{s i z e} ] & i = 1\end{matrix}$$

where i=0, 1 corresponds to the first and second hops, respectively, within a slot. The wireless device 22 applies the starting RB index RBₛₜₐᵣₜ(0) to the first N1 OFDM symbols of the PUSCH transmission and the starting RB index RBₛₜₐᵣₜ(1) to the last N2 OFDM symbols of the PUSCH transmission, where N=N₁+N₂ is the number of OFDM symbols allocated to the PUSCH transmission in the slot.

Embodiment B4. In this embodiment, the teachings of Embodiments B1 to B3 are combined with Group A embodiments based on at least the UL subband size:

The wireless device 22 does not employ frequency hopping for a PUSCH transmission in SBFD symbols if the UL subband size is smaller than a threshold.

In various embodiments of the present disclosure, such threshold value(s) may be configured/preconfigured in wireless device 22 and stored/retrieved in/from memory 88 and/or may be signaled by network node 16.

The wireless device 22 performs a PUSCH transmission with frequency hopping in SBFD symbols based on any of Embodiments B1 to B3 if the UL subband size is no smaller than a threshold.

In one nonlimiting example practice of the embodiment, said threshold is a fixed number. In another nonlimiting example practice of the embodiment, said threshold is a semi-statically configured to the wireless device 22 from the network node 16, for instance, via RRC configuration or via system information transmissions.

### Embodiment Group C (Based on Slot-Dependent FDRA Interpretation)

Embodiment C1. In this embodiment, the allocated RB indices are first determined from the FDRA field, such as an NR FDRA field, for a PUSCH transmission in UL-only symbols. For a PUSCH transmission in SBFD symbols, the allocated RB indices are further adjusted based on a first RB offset

$$R {B}_{offse t 1}^{ULsubband}$$

to ensure that the starting RB falls within the UL subband. That is, the starting RB index is determined, e.g., as:

$$R {B}_{s t a r t} = R {B}_{s t a r t}^{F D R A} + R {B}_{offset 1}^{ULsubband}$$

For example, when

$$R {B}_{offset 1}^{ULsubband} = 101 ,$$

a PUSCH allocated for RB #10

$$( R {B}_{s t a r t}^{F D R A} = 10 )$$

to KB #13 is transmitted in RB #111 to RB #114 (i.e., the first 4 RBs of the UL subband).

If frequency hopping is configured, the wireless device 22 determines the frequency hopping offset RB offset in a NR system for a PUSCH transmission in UL-only symbols. For a first hop of a PUSCH transmission in SBFD symbols, the allocated RB indices are adjusted as above based on a first RB offset. For a second hop of a PUSCH transmission in SBFD symbols, the allocated RB indices are further adjusted based on a second RB offset

$$R {B}_{offset 2}^{ULsubbanad}$$

and the frequency hopping offset RB_{offset} to ensure that the starting RB of the second hop falls within the UL subband. That is, the starting RB indices for the first and second hops are determined, e.g., as:

$$R {B}_{s t a r t} ( {n}_{s , f}^{μ} ) = \{ \begin{matrix}R {B}_{s t a r t}^{FDRA} + {RB}_{offset 1}^{ULsubband} & {n}_{s , f}^{μ} mod 2 = 0 \\ ( {RB}_{s t a r t}^{FDRA} + R {B}_{offset} - R {B}_{offset 2}^{ULsubband} ) mod {N}_{ULsubband}^{s i z e} & {n}_{s , f}^{μ} mod 2 = 1\end{matrix}$$

For example, when

$${RB}_{offset 1}^{ULsubband} = 101 , R {B}_{offset 2}^{ULsubband} = 101 ,$$

a PUSCH allocated for RB #10

$$( R {B}_{s t a r t}^{FDRA} = 10 )$$

to RB #13 with frequency hopping offset RB_{offset}=249, PUSCH is transmitted in SBFD symbols in the following RBs:
In even slots, the wireless device 22 transmits the PUSCH in RB #111 to RB #114 (i.e., the first 4 RBs of the UL subband).
In odd slots, the wireless device 22 transmits the PUSCH in RB #158 to RB #161 (i.e., the last 4 RBs in the UL subband).

In a variation of this embodiment, the wireless device 22 performs intra-slot hopping, and the wireless device 22 computes the PUSCH transmission starting RB index, e.g., as follows:

$$R {B}_{s t a r t} ( i ) = \{ \begin{matrix}R {B}_{s t a r t}^{FDRA} + {RB}_{offset 1}^{ULsubband} & i = 0 \\ ( {RB}_{s t a r t}^{FDRA} + R {B}_{offset} - R {B}_{offset 2}^{ULsubband} ) mod {N}_{ULsubband}^{s i z e} & i = 1\end{matrix}$$

where i=0, 1 corresponds to the first and second hops, respectively, within a slot. The wireless device 22 applies the starting RB index RBₛₜₐᵣₜ(0) to the first N1 OFDM symbols of the PUSCH transmission and the starting RB index RBₛₜₐᵣₜ(1) to the last N2 OFDM symbols of the PUSCH transmission, where N=N₁+N₂ is the number of OFDM symbols allocated to the PUSCH transmission in the slot.

In another variation of this embodiment, if any of the allocated RBs after adjustment of the RB indices for the 1st and 2nd hop fall outside of the UL subband in SBFD symbols, those RBs are not used for the PUSCH transmission.

In one non-limiting example of this embodiment, either or both of the offsets

$$R {B}_{offset 1}^{ULsubband} and {RB}_{offet 2}^{ULsubband}$$

are semi-statically configured to the wireless device 22 from the network node 16, via RRC configuration or via system information transmissions. In another non-limiting example, a list of offsets is semi-statically configured to the wireless device 22 from the network node 16, via RRC configuration or via system information transmissions, and a field in DCI or RAR UL grant indicates which value(s) in the list shall be used by the wireless device 22.

In yet another non-limiting example, instead of explicit signalling of the offset(s) to the wireless device 22, the wireless device 22 determines the offsets implicitly as a function of the bandwidth part size

$${N}_{BWP}^{s i z e} ,$$

UL subband size

$${N}_{ULsubband}^{s i z e} ,$$

DL subband size(s), one or more RB indices of the PUSCH frequency domain resource allocation, PUSCH allocation size, or any combination of these values.

In one non-limiting example of implicit determination, the wireless device 22 determines the first and second offsets, e.g., as follows:

$$R {B}_{offset 1}^{ULsubband} = R {B}_{s t a r t}^{ULsubband} - R {B}_{s t a r t}^{FDRA}$$

$$R {B}_{offet 2}^{ULsubband} = R {B}_{s t a r t}^{FDRA} + R {B}_{offset} - ( R {B}_{s t a r t}^{ULsubband} + {N}_{ULsubband}^{s i z e} - {N}_{PUSCH}^{s i z e} )$$

where

$${N}_{PUSCH}^{s i z e}$$

is the number of contiguous RBs allocated to PUSCH by the FDRA field when Type-1 FDRA is configured. With the same numerical example as above, i.e., PUSCH allocated for RB #10 to RB #13

$$R {B}_{s t a r t}^{F D R A} = 10 and {N}_{PUSCH}^{s i z e} = 4$$

with frequency hopping offset RB_{offset}=249, the wireless device 22 determines the two offsets as

$$R {B}_{offset 1}^{ULsubband} = 111 - 10 = 101 and {RB}_{offset 2}^{ULsubband} = 10 + 249 - ( 111 + 51 - 4 ) = 101.$$

Using the above formula for the starting RB for the 1st and 2nd hops, the transmits PUSCH in SBFD symbols in the following RBs:

In even slots, the wireless device 22 transmits the PUSCH in RB #111 to RB #114 (i.e., the first 4 RBs of the UL subband).

In odd slots, the wireless device 22 transmits the PUSCH in RB #158 to RB #161 (i.e., the last 4 RBs in the UL subband).

While the above implicit approach involves two steps to determine the starting RB index for the 1st and 2nd hop (first calculate RB offsets, then calculate starting RB indices), these two steps may be collapsed into one such that the starting RB index for the 1st and 2nd hop are determined directly, for example from the following formulas:

$$R {B}_{s t a r t} ( {n}_{s , f}^{μ} ) = \{ \begin{matrix}{RB}_{s t a r t}^{ULsubband} & {n}_{s , f}^{μ} mod 2 = 0 \\ {RB}_{s t a r t}^{ULsubband} {N}_{ULsubband}^{s i z e} - {N}_{PUSCH}^{s i z e} ) mod {N}_{ULsubband}^{s i z e} & {n}_{s , f}^{μ} mod 2 = 1\end{matrix}$$

In this non-limiting example, one can see that the first and second RB offsets are transparent to the wireless device 22 and depend only on the start/size of the UL subband and the size of the PUSCH allocation.

If the two offsets always have the same value, then it is not necessary to explicitly or implicitly determine two different offsets.

$$R {B}_{offset1}^{ULsubband} and {RB}_{offset 2}^{ULsubband}$$

can be replaced by a single offset

$$R {B}_{offset}^{ULsubband} .$$

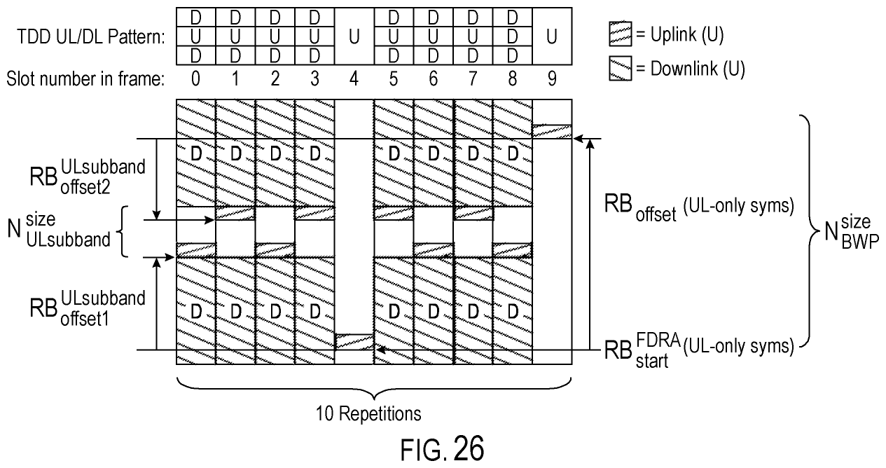

FIG. 26 is an illustration of an example of Embodiment C1 in which the PUSCH is configured for 10 repetitions. The TDD UL/DL pattern including 4 slots with SBFD symbols and 1 slot with UL-only symbols. In other words, the FIG. 26 example of this embodiment is a TDD pattern in which the first 4 slots contain an UL subband and the 5th slot is UL-only. Here it is assumed that multi-slot PUSCH is indicated by DCI with 10 repetitions (2 cycles of the TDD pattern). For UL-only slots 4 and 9, the starting RB and number of RBs for the 1st and 2nd hops and the RB offset for the 2nd hop are determined from the FDRA field, e.g., in an NR system. For the SBFD slots 0, 1, 2, 3, 5, 6, 7, 8, the starting RB for the 1st and 2nd hops are determined according to the formulas in this embodiment, such that they are within the UL subband.

Embodiment C2. In this embodiment, the allocated RB indices are first determined from the FDRA field, e.g., in an NR system, for a PUSCH transmission in UL-only symbols. For a PUSCH transmission in SBFD symbols, the allocated RB indices are based on a first RB offset

$$R {B}_{offset 1}^{ULsubband}$$

relative to the starting RB of the UL subband. That is, the starting RB index is determined, e.g., as:

$$R {B}_{s t a r t} = R {B}_{s t a r t}^{ULsubband} + R {B}_{offset 1}^{ULsubband}$$

For example, when

$${RB}_{offset 1}^{ULsubband} = 2 ,$$

a PUSCH allocated for RB #10 to RB #13 is transmitted in RB #113 to RB #116.

If frequency hopping is configured, the wireless device 22 determines the frequency hopping offset RB_{offset} of an NR system for a PUSCH transmission in UL-only symbols. For a first hop of a PUSCH transmission in SBFD symbols, the allocated RB indices are based on a first RB offset as above. For a second hop of a PUSCH transmission in SBFD symbols, the allocated RB indices based on at least a second RB offset

$$R {B}_{offset 2}^{ULsubband}$$

to ensure that the starting RB of the second hop falls within the UL subband.

As a non-limiting example, the wireless device 22 determines the starting RB for the 1st hop as above and for the 2nd hop additionally based on the number of contiguous RBs

$${N}_{PUSCH}^{s i z e}$$

allocated to PUSCH by the FDRA field when Type-1 FDRA is configured. That is, the starting RBs are determined, e.g., as:

$$R {B}_{s t a r t} ( {n}_{s , f}^{μ} ) = \{ \begin{matrix}{RB}_{s t a r t}^{ULsubband} + {RB}_{offset 1}^{ULsubband} & {n}_{s , f}^{μ} mod 2 = 0 \\ {RB}_{s t a r t}^{ULsubband} {N}_{offset 2}^{s i z e} - {N}_{PUSCH}^{s i z e} ) mod {N}_{ULsubband}^{s i z e} & {n}_{s , f}^{μ} mod 2 = 1\end{matrix}$$

For example, when

$$R {B}_{offset 1}^{ULsubband} = 2 , R {B}_{offset 2}^{ULsubband} = 49 ,$$

a PUSCH allocated for RB #10 to RB #13,

$$( {N}_{PUSCH}^{s i z e} = 4 ) ,$$

the wireless device 22 PUSCH is transmitted in SBFD symbols in the following RBs:
In even slots, the wireless device 22 transmits the PUSCH in RB #113 to RB #116;
In odd slots, the wireless device 22 transmits the PUSCH in RB #156 to RB #159.

In a variation of this example, the wireless device 22 performs intra-slot hopping, and the wireless device 22 computes the PUSCH transmission starting RB index, e.g., as follows:

$${RB}_{start} ( i ) = \{ \begin{matrix}{RB}_{start}^{ULsubband} + {RB}_{offset 1}^{ULsubband} & i = 0 \\ ( {RB}_{start}^{ULsubband} + {RB}_{offset 2}^{ULsubband} - {N}_{PUSCH}^{size} ) mod {N}_{ULsubband}^{size} & i = 1\end{matrix}$$

where i=0, 1 corresponds to the first and second hops, respectively, within a slot. The wireless device 22 applies the starting RB index RBₛₜₐᵣₜ(0) to the first N1 OFDM symbols of the PUSCH transmission and the starting RB index RBₛₜₐᵣₜ(1) to the last N2 OFDM symbols of the PUSCH transmission, where N=N₁+N₂ is the number of OFDM symbols allocated to the PUSCH transmission in the slot.

In another variation of this embodiment, if any of the allocated RBs after adjustment of the RB indices for the 1st and 2nd hop fall outside of the UL subband in SBFD symbols, those RBs are not used for the PUSCH transmission.

In one non-limiting example of this embodiment, either or both of the offsets

$${RB}_{offset 1}^{ULsubband} and {RB}_{offset 2}^{ULsubband}$$

are semi-statically configured to the wireless device 22 from the network node 16, via RRC configuration or via system information transmissions. In another non-limiting example, a list of offsets is semi-statically configured to the wireless device 22 from the network node 16, via RRC configuration or via system information transmissions, and a field in DCI or RAR UL grant indicates which value(s) in the list shall be used by the wireless device 22.

In a variation of this embodiment, instead of explicit signaling of the 2nd offset to the wireless device 22, the wireless device 22 determines the second implicitly as a function of the first offset, the bandwidth part size

$${N}_{BWP}^{size} ,$$

UL subband size

$${N}_{ULsubband}^{size} ,$$

DL subband size(s), or any combination of these values. In one non-limiting example, the wireless device 22 implicitly determines the second offset as a function of the UL subband size and the signaled value of the first offset:

$${RB}_{offset 2}^{ULsubband} = {N}_{ULsubband}^{size} - {RB}_{offset 1}^{ULsubband}$$

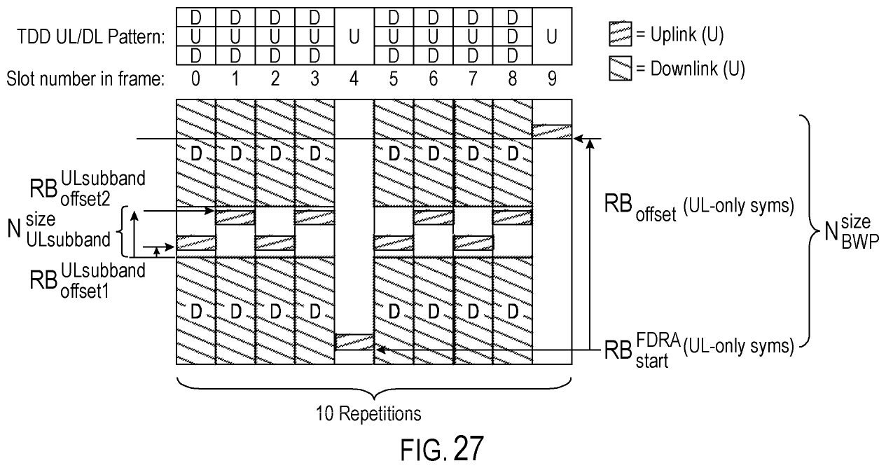

FIG. 27 is an illustration of an example of Embodiment C2 in which the PUSCH is configured for 10 repetitions. The TDD UL/DL pattern includes of 4 slots with SBFD symbols and 1 slot with UL-only symbols. In other words, FIG. 27 shows an example of embodiment for a TDD pattern in which the first 4 slots contain an UL subband and the 5th slot is UL-only. Here it is assumed that multi-slot PUSCH is indicated by DCI with 10 repetitions (2 cycles of the TDD pattern). For UL-only slots 4 and 9, the starting RB and number of RBs for the 1st and 2nd hops and the RB offset for the 2nd hop are determined from the FDRA field, e.g., of an NR system. For the SBFD slots 0, 1, 2, 3, 5, 6, 7, 8, the starting RB for the 1st and 2nd hops are determined according to the formulas in this embodiment, such that they are within the UL subband.

Embodiment C3. In this embodiment, the allocated RB indices are first determined from the FDRA field, e.g., of an NR system, for a PUSCH transmissions in UL-only symbols. For a PUSCH transmission in SBFD symbols, the allocated RB indices are further adjusted based on at least the first UL subband RB index

$${RB}_{start}^{ULsubband} .$$

The allocated RB indices first determined from the FDRA field, e.g., of an NR system, are treated as relative to the first UL subband RB index

$${RB}_{start}^{ULsubband} .$$

That is, the starting RB index is determined, e.g., as:

$${RB}_{start} = {RB}_{start}^{ULsubband} + {RB}_{start}^{FDRA}$$

For example, when

$${RB}_{start}^{ULsubband} = 111 ,$$

a PUSCH allocated for RB #10

$$( {RB}_{start}^{FDRA} = 10 )$$

to RB #13 is transmitted in RB #121 to RB #124.

Embodiment C4. In this embodiment, the allocated RB indices are first determined from the FDRA field, e.g., of an NR system, for a PUSCH transmission in UL-only symbols. For a PUSCH transmission in SBFD symbols, the allocated RB indices are further adjusted based on at least the first UL subband RB index

$${RB}_{start}^{ULsubband}$$

in the same way as Embodiment C3, and additionally based on the UL subband size

$${N}_{ULsubband}^{size} .$$

Those RB indices falling outside of the UL subband are not used for the PUSCH transmission in SBFD symbols.

For example,

$${RB}_{start}^{ULsubband} = 111 and {N}_{ULsubband}^{size} = 51 ,$$

a PUSCH allocated for RB #35

$$( {RB}_{start}^{FDRA} = 35 )$$

to RB #54 (i.e., 20 RBs in total) is transmitted in RB #146 to RB #161 (i.e., 16 RBs in total). This is because the last four RBs (RB #162 to RB #165) are outside of the UL subband.

Embodiment C5. In this, the allocated RB indices are first determined from the FDRA field, e.g., of an NR system, for a PUSCH transmissions in UL-only symbols. For a PUSCH transmission in SBFD symbols, the allocated RB indices are further adjusted based on at least the first UL subband RB index

$${RB}_{start}^{ULsubband}$$

and the UL subband size

$${N}_{ULsubband}^{size} .$$

However, unlike Embodiment C4, those RB indices falling outside of the UL subband are adjusted back into the UL subband range based on a modulo operation. That is, the n-th RB index,

$${RB}_{n}^{FDRA} ,$$

as first determined from the FDRA field, e.g., of an NR system, is adjusted, e.g., as:

$${RB}_{n} = {RB}_{start}^{ULsubband} + ( {RB}_{n}^{FDRA} mod {N}_{ULsubband}^{size} )$$

For example, when

$${RB}_{start}^{ULsubband} = 111 and {N}_{ULsubband}^{size} = 51 ,$$

a PUSCH allocated for RB #35

$$( {RB}_{start}^{FDRA} = 35 ) to RB \#54 ( {RB}_{n}^{FDRA} = 54 )$$

(i.e., 20 RBs in total) is transmitted in RB #146 to RB #161 and in RB #111 to RB #114 (i.e., 20 RBs in total).

In a variation of this embodiment, the RB indices falling outside of the UL subband are adjusted back into the UL subband range such that the resulting PUSCH transmission uses a set of contiguous RBs. That is, the n-th RB index,

$${RB}_{n}^{FDRA} ,$$

as first determined from the FDRA field, e.g., of an NR system, is adjusted, e.g., as:

$${RB}_{n} = {RB}_{start}^{ULsubband} + {RB}_{start}^{FDRA} + ( {RB}_{n}^{FDRA} mod {N}_{ULsubband}^{size} ) - 1$$

For example, when

$${RB}_{start}^{ULsubband} = 111 and {N}_{ULsubband}^{size} = 51 ,$$

a PUSCH allocated for RB #35

$$( {RB}_{start}^{FDRA} = 35 ) to RB \#54 ( {RB}_{n}^{FDRA} = 54 )$$

(i.e., 20 RBs in total) is transmitted in RB #146 to RB #161 and in RB #132 to RB #145 (i.e., 20 RBs in total).

Embodiment C6. In this embodiment, the wireless device 22 uses one of the embodiments from Group A embodiments to determine the frequency hopping offset RB_{offset}. For example, with Embodiment A3, for a PUSCH transmission in SBFD symbols, the wireless device 22 computes the PUSCH transmission starting RB index, e.g., as follows, for inter-slot hopping:

$${RB}_{start} ( {n}_{s , f}^{μ} ) = \{ \begin{matrix}{RB}_{start}^{ULsubband} + {RB}_{start}^{FDRA} & {n}_{s , f}^{μ} mod 2 = 0 \\ ( {RB}_{start}^{ULsubband} + {RB}_{start}^{FDRA} + {RB}_{offset} ) mod {N}_{ULsubband}^{size} & {n}_{s , f}^{μ} mod 2 = 1\end{matrix}$$

For instance, a PUSCH allocated for RB #10

$$( {RB}_{start}^{FDRA} = 10 )$$

to RB #13 and a frequency hopping offset of

$${RB}_{offset} = ⌊ {N}_{ULsubband}^{size} / 2 ⌋ = 25$$

is transmitted in SBFD symbols in the following RBs:
In even slots, the wireless device 22 transmits the PUSCH in RB #121 to RB #124.
In odd slots, the wireless device 22 transmits the PUSCH in RB #146 to RB #149.
   The starting RB index is computed according to the above formula: (111+10+25) mod 51=146.

In a variation of this embodiment, the wireless device 22 performs intra-slot hopping, and the wireless device 22 computes the PUSCH transmission starting RB index, e.g., as follows:

$${RB}_{start} ( i ) = \{ \begin{matrix}{RB}_{start}^{ULsubband} + {RB}_{start}^{FDRA} & i = 0 \\ ( {RB}_{start}^{ULsubband} + {RB}_{start}^{FDRA} + {RB}_{offset} ) mod {N}_{ULsubband}^{size} & i = 1\end{matrix}$$

where i=0, 1 corresponds to the first and second hops, respectively, within a slot. The wireless device 22 applies the starting RB index RBₛₜₐᵣₜ(0) to the first N1 OFDM symbols of the PUSCH transmission and the starting RB index RBₛₜₐᵣₜ(1) to the last N2 OFDM symbols of the PUSCH transmission, where N=N₁+N₂ is the number of OFDM symbols allocated to the PUSCH transmission in the slot.

Embodiment C7. In a combination of Embodiments C4 and C6, only those RBs falling in the UL subband are to be utilized for the PUSCH transmission in SBFD symbols by the wireless device 22.

As an example, a PUSCH is allocated for RB #10 to RB #29 (i.e., 20 RBs in total) and a frequency hopping offset of

$${RB}_{offset} = ⌊ {N}_{ULsubband}^{size} / 2 ⌋ = 25$$

is transmitted in SBFD symbols in the following RBs:
In even slots, the wireless device 22 transmits the PUSCH in RB #121 to RB #140 (i.e., 20 RBs in total).
In odd slots, the wireless device 22 transmits the PUSCH in RB #145 to RB #161 (i.e., 16 RBs in total).
   The starting RB index is computed as in the first example in Embodiment C4. If the UL subband is large enough, then the PUSCH would be transmitted in RB #146 to RB #165. However, the last four RBs are outside of the UL subband and hence are not available. According to the teaching of the embodiments, the transmits the PUSCH only in RB #146 to RB #161.

Embodiment C8. In a combination of Embodiments C5 and C6, those RB indices falling outside of the UL subband are adjusted back into the UL subband range based on a modulo operation.

As an example, a PUSCH is allocated for RB #10 to RB #29 (i.e., 20 RBs in total) and a frequency hopping offset of

$${RB}_{offset} = ⌊ {N}_{ULsubband}^{size} / 2 ⌋ = 25$$

is transmitted in SBFD symbols in the following RBs:
In even slots, the wireless device 22 transmits the PUSCH in RB #121 to RB #140 (i.e., 20 RBs in total).
In odd slots, the wireless device 22 transmits the PUSCH in RB #145 to RB #161 and from RB #111 to RB #114 (i.e., 20 RBs in total).

Embodiment C9. In this embodiment, the teachings of Embodiments C1 to C8 are combined with Group A embodiments based on at least the UL subband size:
The wireless device 22 does not employ frequency hopping for a PUSCH transmission with frequency hopping in SBFD symbols if the UL subband size is smaller than a threshold.
The wireless device 22 performs a PUSCH transmission with frequency hopping in SBFD symbols based on any of Embodiments C1 to C8 if the UL subband size is no smaller than a threshold.

In one nonlimiting example practice of the embodiment, said threshold is a fixed number. In another nonlimiting example practice of the embodiment, said threshold is a semi-statically configured to the wireless device 22 from the network node 16, for instance, via RRC configuration or via system information transmissions

The above example embodiments have been described with respect to the PUSCH, but it is to be understood that the teachings of embodiments of the present disclosure may be applicable to configuring any suitable uplink channel for subband full duplex operation.

### EXAMPLES

Example D1. A network node 16 configured to communicate with a wireless device 22 (WD 22), the network node 16 configured to, and/or comprising a radio interface and/or comprising processing circuitry configured to:
store an uplink channel configuration, the uplink channel configuration including a first frequency hopping configuration and a second frequency hopping configuration;
determine a first configuration for a first uplink transmission based on the uplink channel configuration, the first configuration including at least one subband full duplex (SBFD) symbol associated with the first frequency hopping configuration and at least one uplink-only symbol associated with the second frequency hopping configuration; and
receive the first uplink transmission based on the first configuration.

Example D2. The network node 16 of Example D1, wherein the network is further configured to:
determine a first scheduling grant based on the first configuration;
cause transmission of the first scheduling grant to the wireless device 22; and
the receiving of the first uplink transmission being further based on the first scheduling grant.

Example D3. The network node 16 of any one of Examples D1 and D2, wherein:
the first frequency hopping configuration associated with the at least one SBFD symbol includes at least one of:
   not applying frequency hopping to the at least one SBFD symbol; and
   applying a first set of frequency hopping offsets to the at least one SBFD symbol; and
the second frequency hopping configuration associated with the at least one uplink-only symbol includes at least one of:
   applying frequency hopping to the at least one uplink-only symbol; and
   applying a second set of frequency hopping offsets to the at least one uplink-only symbol.

Example D4. The network node 16 of Example D3, wherein:
the first set of frequency hopping offsets is determined based on an uplink bandwidth part size; and
the second set of frequency hopping offsets is determined based on an uplink subband size.

Example D5. The network node 16 of any one of Examples D1-D4, wherein the determining of the first configuration further includes:
determining a plurality of allocated resource blocks (RB);
determining an uplink subband associated with the first uplink transmission; and
at least one of:
   the allocated RBs being mapped to the at least one SBFD symbol being based on the allocated RBs being within the uplink subband; and
   the allocated RBs being adjusted based on a first RB offset, a starting RB of the adjusted allocated RBs being within the uplink subband.

Example D6. The network node 16 of any one of Examples D1-D5, wherein the network node 16 is further configured to:
determine an uplink subband associated with the first uplink transmission; and
the first frequency hopping configuration associated with the at least one SBFD symbol includes not applying frequency hopping to the at least one SBFD symbol based on the uplink subband being smaller than a threshold associated with the uplink channel configuration.

Example E1. A method implemented in a network node 16, the method comprising:
storing an uplink channel configuration, the uplink channel configuration including a first frequency hopping configuration and a second frequency hopping configuration;
determining a first configuration for a first uplink transmission based on the uplink channel configuration, the first configuration including at least one subband full duplex (SBFD) symbol associated with the first frequency hopping configuration and at least one uplink-only symbol associated with the second frequency hopping configuration; and
receiving the first uplink transmission based on the first configuration.

Example E2. The method of Example E1, further comprising:
determining a first scheduling grant based on the first configuration;
causing transmission of the first scheduling grant to the wireless device 22; and
the receiving of the first uplink transmission being further based on the first scheduling grant.

Example E3. The method of any one of Examples E1 and E2, wherein:
the first frequency hopping configuration associated with the at least one SBFD symbol includes at least one of:
   not applying frequency hopping to the at least one SBFD symbol; and
   applying a first set of frequency hopping offsets to the at least one SBFD symbol; and
the second frequency hopping configuration associated with the at least one uplink-only symbol includes at least one of:
   applying frequency hopping to the at least one uplink-only symbol; and
   applying a second set of frequency hopping offsets to the at least one uplink-only symbol.

Example E4. The method of Example E3, wherein:
the first set of frequency hopping offsets is determined based on an uplink bandwidth part size; and
the second set of frequency hopping offsets is determined based on an uplink subband size.

Example E5. The method of any one of Examples E1-E4, wherein the determining of the first configuration further includes:
determining a plurality of allocated resource blocks (RB);
determining an uplink subband associated with the first uplink transmission; and
at least one of:
   the allocated RBs being mapped to the at least one SBFD symbol being based on the allocated RBs being within the uplink subband; and
   the allocated RBs being adjusted based on a first RB offset, a starting RB of the adjusted allocated RBs being within the uplink subband.

Example E6. The method of any one of Examples E1-E5, further comprising:
determining an uplink subband associated with the first uplink transmission; and
the first frequency hopping configuration associated with the at least one SBFD symbol includes not applying frequency hopping to the at least one SBFD symbol based on the uplink subband being smaller than a threshold associated with the uplink channel configuration.

Example F1. A wireless device 22 (WD 22) configured to communicate with a network node 16, the WD 22 configured to, and/or comprising a radio interface and/or processing circuitry configured to:
receive, from the network node 16, an uplink channel configuration, the uplink channel configuration including a first frequency hopping configuration and a second frequency hopping configuration;
determine a first configuration for a first uplink transmission based on the uplink channel configuration, the first configuration including at least one subband full duplex (SBFD) symbol associated with the first frequency hopping configuration and at least one uplink-only symbol associated with the second frequency hopping configuration; and
cause transmission of the first uplink transmission based on the first configuration.

Example F2. The WD 22 of Example F1, wherein the wireless device 22 is further configured to:
receive a first scheduling grant from the network node 16; and
the determining of the first configuration for the first uplink transmission being further based on the first scheduling grant.

Example F3. The WD 22 of any one of Examples F1 and F2, wherein:
the first frequency hopping configuration associated with the at least one SBFD symbol includes at least one of:
   not applying frequency hopping to the at least one SBFD symbol; and
   applying a first set of frequency hopping offsets to the at least one SBFD symbol; and
the second frequency hopping configuration associated with the at least one uplink-only symbol includes at least one of:
   applying frequency hopping to the at least one uplink-only symbol; and
   applying a second set of frequency hopping offsets to the at least one uplink-only symbol.

Example F4. The WD 22 of Example F3, wherein:
the first set of frequency hopping offsets is determined based on an uplink bandwidth part size; and
the second set of frequency hopping offsets is determined based on an uplink subband size.

Example F5. The WD 22 of any one of Examples F1-F4, wherein the determining of the first configuration further includes:
determining a plurality of allocated resource blocks (RB);
determining an uplink subband associated with the first uplink transmission; and
at least one of:
   the allocated RBs being mapped to the at least one SBFD symbol being based on the allocated RBs being within the uplink subband; and
   the allocated RBs being adjusted based on a first RB offset, a starting RB of the adjusted allocated RBs being within the uplink subband.

Example F6. The WD 22 of any one of Examples F1-F5, wherein the wireless device 22 is further configured to:
determine an uplink subband associated with the first uplink transmission; and
the first frequency hopping configuration associated with the at least one SBFD symbol includes not applying frequency hopping to the at least one SBFD symbol based on the uplink subband being smaller than a threshold associated with the uplink channel configuration.

Example G1. A method implemented in a wireless device 22 (WD 22), the method comprising:
receiving, from the network node 16, an uplink channel configuration, the uplink channel configuration including a first frequency hopping configuration and a second frequency hopping configuration;
determining a first configuration for a first uplink transmission based on the uplink channel configuration, the first configuration including at least one subband full duplex (SBFD) symbol associated with the first frequency hopping configuration and at least one uplink-only symbol associated with the second frequency hopping configuration;
causing transmission of the first uplink transmission based on the first configuration.

Example G2. The method of Example G1, further comprising:
receiving a first scheduling grant from the network node 16; and
the determining of the first configuration for the first uplink transmission being further based on the first scheduling grant.

Example G3. The method of any one of Examples G1 and G2, wherein:
the first frequency hopping configuration associated with the at least one SBFD symbol includes at least one of:
   not applying frequency hopping to the at least one SBFD symbol; and
   applying a first set of frequency hopping offsets to the at least one SBFD symbol; and
the second frequency hopping configuration associated with the at least one uplink-only symbol includes at least one of:
   applying frequency hopping to the at least one uplink-only symbol; and
   applying a second set of frequency hopping offsets to the at least one uplink-only symbol.

Example G4. The method of Example G3, wherein:
the first set of frequency hopping offsets is determined based on an uplink bandwidth part size; and
the second set of frequency hopping offsets is determined based on an uplink subband size.

Example G5. The method of any one of Examples G1-G4, wherein the determining of the first configuration further includes:
determining a plurality of allocated resource blocks (RB);
determining an uplink subband associated with the first uplink transmission; and
at least one of:
   the allocated RBs being mapped to the at least one SBFD symbol being based on the allocated RBs being within the uplink subband; and
   the allocated RBs being adjusted based on a first RB offset, a starting RB of the adjusted allocated RBs being within the uplink subband.

Example G6. The method of any one of Examples G1-G5, further comprising:
determining an uplink subband associated with the first uplink transmission; and
the first frequency hopping configuration associated with the at least one SBFD symbol includes not applying frequency hopping to the at least one SBFD symbol based on the uplink subband being smaller than a threshold associated with the uplink channel configuration.

The above example embodiments have been described with respect to processes which occur at the wireless device 22, but it is to be understood that the same and/or analogous processes may occur at one or more network nodes 16, e.g., in communication with wireless device 22. For example, a network node 16 may be configured with the same or similar uplink configuration as the wireless device 22, such that the network node 16 is able to properly receive, decode, interpret, etc. the uplink transmission received from the wireless device 22 in accordance with the configuration. The network node 16 which receives the uplink transmission from the wireless device 22 may, for example, be preconfigured with the same or similar configuration/parameters as the wireless device, so that the network node 16 and the wireless device 22 do not necessarily need to exchange configuration information, e.g., before each uplink transmission, in order to send and receive uplink communications in accordance with the configuration. Further, network node 16 may receive and/or store information regarding configurations/parameters/capabilities/status/scheduling/etc. of wireless device 22, and network node 16 may use that information to determine the uplink configuration it expects the wireless device 22 to use, so that network node 16 may properly receive, decode, interpret, etc. the uplink transmission.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to:
receive control signaling for controlling a physical uplink shared channel, PUSCH, transmission; and
perform the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

2. The wireless device of claim 1, wherein the control signaling includes a frequency hopping configuration.

3. (canceled)

4. (canceled)

5. The wireless device of claim 2, wherein the frequency hopping configuration includes a plurality of preconfigured frequency hopping offsets; and
the wireless device is further configured to:
perform at least one of inter-slot frequency hopping and intra-slot frequency hopping in the at least one UL-only symbol based on a first frequency hopping offset included in a first subset of the plurality of preconfigured frequency hopping offsets; and
perform at least one of inter-slot frequency hopping and intra-slot frequency hopping in the at least one SBFD symbol based on a second frequency hopping offset included in a second subset of the plurality of preconfigured frequency hopping offsets.

6. The wireless device of claim 2, wherein the frequency hopping configuration includes one or both of:
an SBFD frequency offset that is based on an UL subband size of the at least one SBFD symbol; and
an indication of a first frequency hopping offset used for frequency hopping in the at least one UL-only symbol and a second frequency hopping offset used for frequency hopping in the at least one SBFD symbol.

7.-9. (canceled)

10. The wireless device of claim 1, wherein the PUSCH transmission is allocated resource blocks in the at least one SBFD symbol based on at least one of a subband size of an UL subband of the at least one SBFD symbol and a frequency domain location of the UL subband of the at least one SBFD symbol.

11. (canceled)

12. The wireless device of claim 1, wherein the control signaling includes an indication of a resource block, RB, allocation in a frequency domain for the at least one UL-only symbol, the indication including at least an indication of a starting RB for the RB allocation in the frequency domain for the at least one UL-only symbol.

13. (canceled)

14. The wireless device of claim 2, wherein the frequency hopping configuration includes a first frequency hopping offset used for at least one of inter-slot frequency hopping and intra-slot frequency hopping in the at least one UL-only symbol and at least one of a second and a third frequency hopping offset used for at least one of inter-slot frequency hopping and intra-slot frequency hopping in the at least one SBFD symbol.

15.-22. (canceled)

23. The wireless device of claim 1, wherein a starting resource block allocated for the uplink transmission in the at least one SBFD symbol is determined based on a starting resource block of an UL subband of the at least one SBFD symbol.

24. The wireless device of claim 1, wherein resource blocks of the uplink transmission allocated outside resource blocks of an UL subband of the at least one SBFD symbol are at least one of:
dropped; and
re-allocated to a subset of the resource blocks of the UL subband.

25. A method performed on a wireless device, the method comprising:
receiving control signaling for a physical uplink shared channel, PUSCH, transmission; and
performing the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

26.-48. (canceled)

49. A network node configured to communicate with a wireless device, the network node configured to:
transmit, to the wireless device, control signaling for a physical uplink shared channel, PUSCH, transmission; and
receive the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

50. The network node of claim 49, wherein the control signaling includes a frequency hopping configuration.

51.-53. (canceled)

54. The network node of claim 50, wherein the frequency hopping configuration includes one or both of:
an SBFD frequency offset that is based on an UL subband size of the at least one SBFD symbol; and
an indication of a first frequency hopping offset used for frequency hopping in the at least one UL-only symbol and a second frequency hopping offset used for frequency hopping in the at least one SBFD symbol.

55.-57. (canceled)

58. The network node of claim 49, wherein the PUSCH transmission is allocated resource blocks in the at least one SBFD symbol based on at least one of a subband size of an UL subband of the at least one SBFD symbol and a frequency domain location of the UL subband of the at least one SBFD symbol.

59. (canceled)

60. The network node of claim 49, wherein the control signaling includes an indication of a resource block, RB, allocation in a frequency domain for the at least one UL-only symbol, the indication including at least an indication of a starting RB for the RB allocation in the frequency domain for the at least one UL-only symbol.

61.-72. (canceled)

73. A method performed on a network node, the method comprising:
transmitting, to a wireless device, control signaling for a physical uplink shared channel, PUSCH, transmission; and
receiving the PUSCH transmission based on the control signaling, the PUSCH transmission spanning a plurality of slots, the plurality of slots including at least one slot containing at least one uplink-, UL-, only symbol and at least one slot containing at least one subband full duplex, SBFD, symbol, the PUSCH transmission spanning the at least one UL-only symbol and the at least one SBFD symbol.

74.-96. (canceled)

97. The wireless device of claim 5, wherein the frequency hopping configuration includes one or both of:
an SBFD frequency offset that is based on an UL subband size of the at least one SBFD symbol; and
an indication of a first frequency hopping offset used for frequency hopping in the at least one UL-only symbol and a second frequency hopping offset used for frequency hopping in the at least one SBFD symbol.

98. The wireless device of claim 2, wherein the PUSCH transmission is allocated resource blocks in the at least one SBFD symbol based on at least one of a subband size of an UL subband of the at least one SBFD symbol and a frequency domain location of the UL subband of the at least one SBFD symbol.

99. The wireless device of claim 5, wherein the PUSCH transmission is allocated resource blocks in the at least one SBFD symbol based on at least one of a subband size of an UL subband of the at least one SBFD symbol and a frequency domain location of the UL subband of the at least one SBFD symbol.

100. The wireless device of claim 2, wherein the control signaling includes an indication of a resource block, RB, allocation in a frequency domain for the at least one UL-only symbol, the indication including at least an indication of a starting RB for the RB allocation in the frequency domain for the at least one UL-only symbol.
